(19) United States
(12) Patent Application Publication
(10) Pub. No.: US 2026/0189180 A1
(43) Pub. Date: Jul. 2, 2026

(54) METHODS, SYSTEMS, AND APPARATUSES FOR SOLAR ENERGY COLLECTION FOR MARINE VESSELS

(71) Applicant: Voltic Shipping Corp., Laughlintown, PA (US)

(72) Inventors: Prosser Cathey, Laughlintown, PA (US); Hudson Hooper, Omaha, NE (US); Jared Boisvert, Whitney, TX (US); Fiyi Adebekun, New York, NY (US)

(21) Appl. No.: 19/549,113

(22) Filed: Feb. 25, 2026

Related U.S. Application Data
(63) Continuation of application No. PCT/US2024/044895, filed on Aug. 30, 2024.
(60) Provisional application No. 63/536,320, filed on Sep. 1, 2023.

(51) Int. Cl. H02S 20/30; B63B 27/36; B63B 35/36; B63B 35/44; B63B 59/02; H02S 30/20; H02S 40/10

(52) U.S. Cl. CPC H02S 20/30; B63B 35/44; H02S 30/20; H02S 40/10; B63B 27/36; B63B 35/36; B63B 2035/4453; B63B 59/02; B63B 2209/18

(57) ABSTRACT

Apparatuses for marine vessels to maximize solar energy collection are provided, along with systems and methods relating thereto. In some embodiments, an apparatus is mounted on the top of a marine vessel and extends its surface area, facilitating optimal sun exposure for solar panels. In some embodiments, prior to docking, the apparatus can be folded and rotated to fit within the original ship's profile, allowing for efficient cargo loading and unloading from the top as is standard in the cargo industry. In some embodiments, an apparatus comprises a plurality of solar panels and a plurality of skids configured to trail behind a stern portion of a marine vessel.

### CROSS-REFERENCE TO RELATED APPLICATIONS

This application is a continuation of International Application no. PCT/US2024/044895, filed on Aug. 30, 2024, which claims the benefit of priority to U.S. Provisional Application No. 63/536,320, filed on Sep. 1, 2023, which are hereby incorporated by reference in their entirety.

### FIELD

The subject matter described herein relates generally to apparatuses for solar energy collection for marine vessels, as well as systems and methods relating thereto.

### BACKGROUND

At present, the shipping industry primarily relies on conventional fuel-powered vessels to transport goods across the world's waterways. These ships typically run on heavy fuel oil, which can emit significant amounts of greenhouse gases. Shipping accounts for approximately 2.2% of global carbon dioxide (CO2) production, along with approximately 15% nitrogen oxide (NOx) and 13% sulfur oxide (SOx) production.

Efforts to mitigate the environmental impact of shipping have been met with mixed results. For example, slow steaming is an approach adopted by some shipping companies that involves reducing vessel speed to decrease fuel consumption. While this helps to some extent, it does not address the fundamental issue of emissions from fossil fuels. Another approach is the use of alternative fuels, such as liquified natural gas (LNG) or biofuels. LNG has lower emissions compared to traditional fuels, but still contributes to greenhouse gas emissions. Biofuels offer a renewable alternative, but their availability and scalability are limited.

As yet another approach, some ships use scrubbers or exhaust gas cleaning systems to reduce emissions of sulfur oxides. These systems remove pollutants from exhaust gases, but still do not eliminate carbon emissions or address other environmental concerns. The shipping industry has also attempted to improve the energy efficiency of marine vessels through measures like hull optimization, better propulsion systems, and waste heat recovery. While these measures can help reduce fuel consumption and emissions, they are still limited in their effectiveness.

In addition to the environmental impact, fuel also carries a significant financial cost. As a percentage of total operating cost to a shipping company, for example, fuel can comprise an amount between 15% to 45%, depending on the route, weight, ship type and other factors. Overall, the current state of the art in the shipping industry involves incremental improvements to reduce emissions and enhance energy efficiency. However, these approaches fall short of providing a comprehensive solution to the environmental and economic challenges posed by shipping.

Solar power offers a sustainable alternative to fossil fuels for the marine industry, specifically for cargo transportation. Powering marine vessels with solar energy could eliminate emissions and reduce the financial cost to shipping companies at the same time.

Due to the limited surface area of these vessels, however, it becomes challenging to install a sufficient number of solar panels to generate significant solar energy. Additionally, when docked, cargo loading and unloading processes often require unobstructed access to the vessel's deck.

Thus, needs exist for a foldable, rotatable, and retractable apparatuses for solar energy collection for marine vessels.

### SUMMARY

Provided herein are example embodiments of apparatuses for solar energy collection for marine vessels, along with systems and methods relating thereto. Aspects of the inventions are set out in the independent claims and preferred features are set out in the dependent claims. Preferred features of each aspect may be provided in combination with each other within particular embodiments and may also be provided in combination with other aspects.

According to some embodiments, an apparatus for collecting solar energy for a marine vessel is provided. The apparatus comprises a first subassembly comprising a first plurality of compactible solar panels, a first plurality of rails coupled with a hull of the marine vessel, and a first rotational mechanism coupled with the first plurality of compatible solar panels and the first plurality of rails. The apparatus also comprises a second subassembly comprising a second plurality of compactible solar panels, a second plurality of rails coupled with the hull of the marine vessel, and a second rotational mechanism coupled with the second plurality of compactible solar panels and the second plurality of rails. According to some embodiments, the first subassembly and the second subassembly are configured to transform between a plurality of configurations, including an expanded configuration and a compacted configuration, wherein, in the expanded configuration, the first plurality of compactible solar panels and the second plurality of solar panels define a substantially planar surface having a total surface area greater than or equal to a top surface area of the hull.

According to some embodiments, another apparatus for collecting solar energy for a marine vessel is provided, in which the apparatus comprises a single subassembly comprising a plurality of compactible solar panels, a plurality of rails coupled with a hull of the marine vessel, and a rotational mechanism coupled with the plurality of compactible solar panels and the plurality of rails. According to some embodiments, the subassembly is configured to transform between a plurality of configurations, including an expanded configuration and a compacted configuration, wherein, in the expanded configuration, the plurality of compactible solar panels defines a substantially planar surface having a total surface area greater than or equal to a top surface area of the hull.

According to some embodiments, another apparatus for collecting solar energy for a marine vessel is provided, in which the apparatus comprises: a plurality of solar panels configured to transform between a plurality of configurations, including a deployed configuration and a stored configuration; a plurality of skids coupled with the plurality of solar panels; and a storage system configured for storing the plurality of solar panels in the stored configuration; wherein, in the deployed configuration, the plurality of solar panels and the plurality of skids are configured to trail behind a stern portion of the marine vessel on a water surface, and wherein, in the stored configuration, the plurality of solar panels are configured to be stored in the storage system in or on the marine vessel. According to some embodiments, while in the deployed configuration, the plurality of solar panels and the plurality of skids form a trailing platform. In some embodiments, while in the deployed configuration, the trailing platform is configured to be operatively tethered to the stern portion of the marine vessel. In addition, in some embodiments, while in the stored configuration, the plurality of solar panels are configured to be in a rolled-up state and disposed in the storage system. In some embodiments, the storage system can comprise a drum.

The embodiments provided herein improve upon shipping and marine vessels by making them more environmentally friendly, by reducing or eliminating the emissions of greenhouse gases, and more economical, by reducing or eliminating the consumption of traditional fossil fuels. The various configurations of the apparatuses are described in detail by way of the embodiments which are only examples.

Other systems, devices, methods, features and advantages of the subject matter described herein will be or will become apparent to one with skill in the art upon examination of the following figures and detailed description. Where a method is described and claimed herein, apparatuses and systems comprising means for performing each of the steps of the method are also expressly disclosed and provided. Moreover, computer programs, computer program products and computer readable media for implementing the steps of the method are also disclosed and provided. It is intended that all such additional systems, devices, methods, features, and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is a perspective view depicting an example embodiment of an apparatus for solar energy collection for a marine vessel.

FIG. 2 is a perspective view depicting an example embodiment of an apparatus for solar energy collection for a marine vessel in a compacted configuration.

FIG. 3 is a perspective view depicting an example embodiment of an apparatus for solar energy collection for a marine vessel in another compacted configuration.

FIG. 4 is a perspective view depicting an example embodiment of an apparatus for solar energy collection for a marine vessel with a first and a second subassembly rotated to 45 degree angles.

FIG. 5 is a perspective view depicting an example embodiment of an apparatus for solar energy collection for a marine vessel with a first and a second subassembly rotated to 90 degree angles.

FIG. 6 is a perspective view depicting an example embodiment of an apparatus for solar energy collection for a marine vessel in a partially expanded configuration.

FIG. 7 is a perspective view depicting an example embodiment of an apparatus for solar energy collection for a marine vessel in an expanded configuration.

FIG. 8 is a perspective view depicting an example embodiment of a rotational mechanism.

FIG. 9 is a perspective view depicting an example embodiment of a holding piece of the rotational mechanism.

FIG. 10A is a perspective view depicting an example embodiment of a panel section.

FIG. 10B is a perspective view depicting an example embodiment of a support piece.

FIG. 11 is a perspective view depicting an example embodiment of a panel structure.

FIG. 12 is a perspective view including a close-up view, depicting an example embodiment of a rolling beam.

FIG. 13 is a perspective view depicting an example embodiment of a small structure.

FIG. 14 is a perspective view depicting an example embodiment of a large structure.

FIG. 15 is a perspective view depicting an example embodiment of a dressed support structure.

FIG. 16 is a perspective view depicting an example embodiment of a barge with rails.

FIG. 17 is a flow diagram for an example embodiment of a method for loading and unloading cargo for use with the apparatuses described herein.

FIGS. 18 and 18A are, respectively, a perspective view and call-out view of an example embodiment of a trailing apparatus for solar energy collection for a marine vessel.

FIGS. 18B to 18D are perspective views of an example embodiment of a trailing apparatus for solar energy collection for a marine vessel, as shown in different stages of operation.

FIG. 19 is a perspective view of an example embodiment of a skid for a trailing apparatus for solar energy collection for a marine vessel.

FIGS. 20A and 20B are perspective views of example embodiments of skids for a trailing apparatus.

FIGS. 21A to 21L are perspective and diagrammatic views of example embodiments of solar panel storage systems.

FIGS. 22A to 22C are diagrammatic and perspective view of example embodiments of solar panel storage translation systems.

FIG. 23 is a diagrammatic side view of an example embodiment of a deck extension for solar energy collection for a marine vessel.

FIG. 24 is a partial perspective view of an example embodiment of a deployment/withdrawal mechanism for solar panels for a marine vessel.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

As used herein and in the appended claims, the singular forms “a,” “an,” and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

### Examples of Materials for Apparatuses for Collecting Solar Energy for a Marine Vessel

Before describing the aspects of the embodiments in detail, it is first desirable to describe examples of materials that can be present within, for example, an apparatus for collecting solar energy for a marine vessel, as well as examples of materials that can be used in conjunction with such apparatuses and their operation, all of which can be used with the embodiments described herein.

The apparatus and all of the various items associated with it may be made up of a variety of materials including but not limited to the following examples. When a material is listed, it is implied that all variants or alloys (if applicable) are with the scope of the present disclosure. For example, “steel” is meant to include different types such as carbon steel, alloy steel, stainless steel, and all other compositions. Furthermore, those of skill in the art will appreciate that all grades of the material are within the scope of the present disclosure, and that varying manufacturing methods do not constitute a new or different material.

According to one aspect of the embodiments disclosed herein, the hull materials used for a marine vessel can vary from one vessel to another, depending on the chosen hull design and performance goals. In some embodiments, hull materials can include iron and steel. In lightweight embodiments, parts of a hull or the entire hull may be made out of aluminum. In other embodiments, alternatives to metal hulls that may be used in combination with the apparatus also include but are not limited to fiber-reinforced polymer (FRP), polyurethane, and carbon fiber materials.

In some embodiments of marine vessels, the hull material can comprise a composite material, or combinations of materials, such as, for example fiberglass, carbon fiber, and epoxy resins. Composites offer high strength-to-weight ratios and can be molded into complex shapes.

In some embodiments of marine vessels, the hull material may comprise titanium. Titanium can be exceptionally strong and corrosion-resistant and can be used in specialized vessels and submarines.

In some embodiments of marine vessels, the hull material can comprise ceramics. For example, in some embodiments advanced ceramics like silicon carbide and boron carbide offer excellent hardness and resistance to extreme temperatures. Ceramics can be used in hull material for use in military and high-performance vessels.

In some embodiments of marine vessels, the hull material can comprise graphene, which can be a super-strong, lightweight material that has unique properties like high electrical and thermal conductivity.

In some embodiments of marine vessels, the hull material can comprise nanostructured materials, which can offer enhanced strength, toughness, and corrosion resistance.

In some embodiments of marine vessels, the hull material can comprise fiber-reinforced polymers (FRP), which are composite materials with strong fibers (e.g., glass or carbon) embedded in a polymer matrix. Such materials offer good strength and corrosion resistance.

In some embodiments of marine vessels, the hull material can comprise advanced plastics. Such high-performance plastics, such as, for example, polyether ether ketone (PEEK) or polyphenylene sulfide (PPS), are lightweight and have corrosion-resistant properties.

In some embodiments of marine vessels, the hull material can comprise shape memory alloys, which can “remember” their original shape and return to it when heated. These materials can have applications in adaptive ship hulls, changing shape to optimize hydrodynamics.

In some embodiments of marine vessels, the hull material can comprise hybrid materials, which combine different materials, like steel and composites, and can create hybrid hulls that balance the strengths of each material.

In some embodiments of marine vessels, the hull material can comprise bio-based materials. These sustainable shipbuilding materials can include bio-based polymers and natural fibers to reduce environmental impact.

In some embodiments of marine vessels, the hull material can comprise self-healing materials. These materials can be embedded with microcapsules of healing agents, that can be configured to automatically repair minor damage, increasing the hull's longevity.

In some embodiments of marine vessels, the hull material can comprise metal foams. These materials are lightweight and impact-resistant and can absorb energy from impact and reduce damage to the hull.

In some embodiments of marine vessels, the hull material can comprise advanced coatings. Advanced coatings can have self-cleaning, anti-fouling, and corrosion-resistant properties that can enhance the durability of ship hulls.

In some embodiments of marine vessels, the hull material may comprise liquid crystal polymers. These materials can change shape in response to external stimuli.

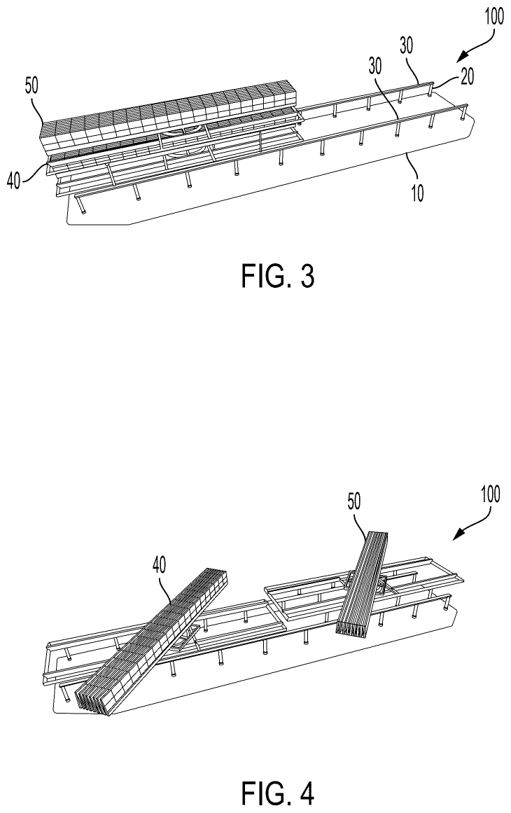

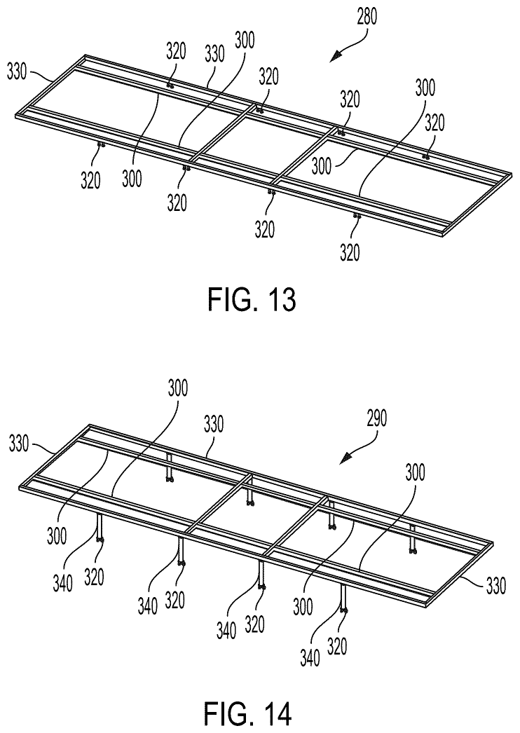

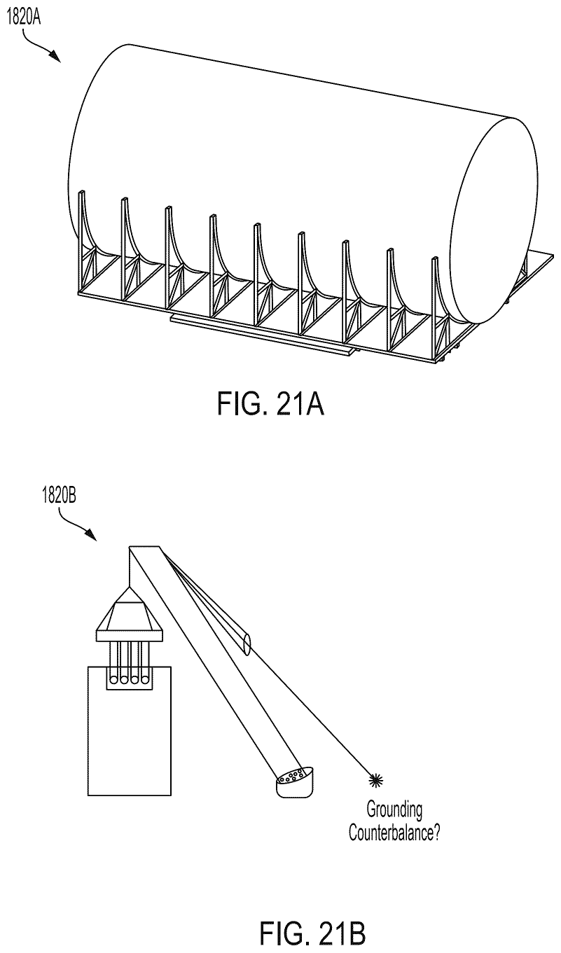

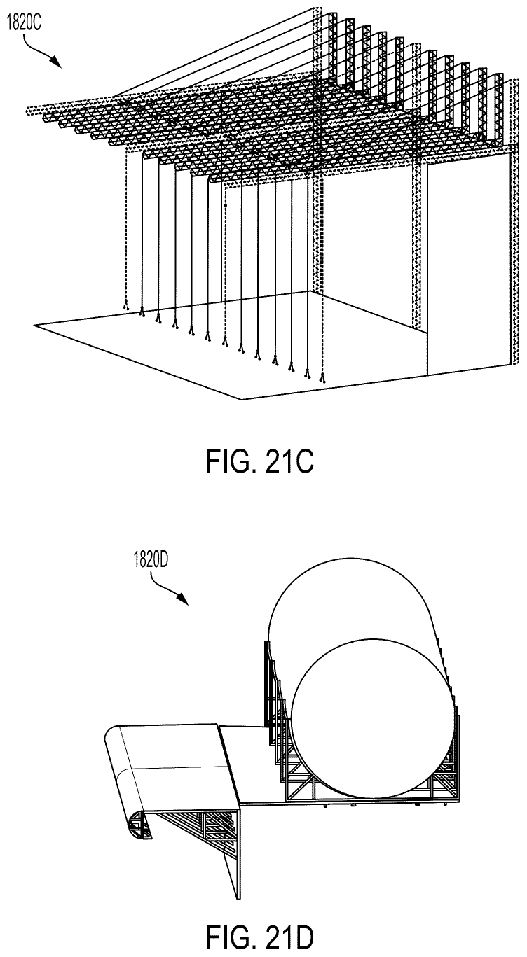

According to another aspect of the embodiments, various types of rails are disclosed herein for use with an apparatus for collecting solar energy for a marine vessel. The various rail embodiments throughout the apparatus can include, for example, main rails 30 (FIG. 2), base structure rails 310 (FIG. 15), and rails on the support structure 220 (FIG. 8). The various rail embodiments can be made using different or the same materials. In many embodiments, these rails can be made from common materials used for other types of rails, such as iron or steel. In some embodiments, any of the aforementioned materials described with respect to the hull, can also be applicable here.

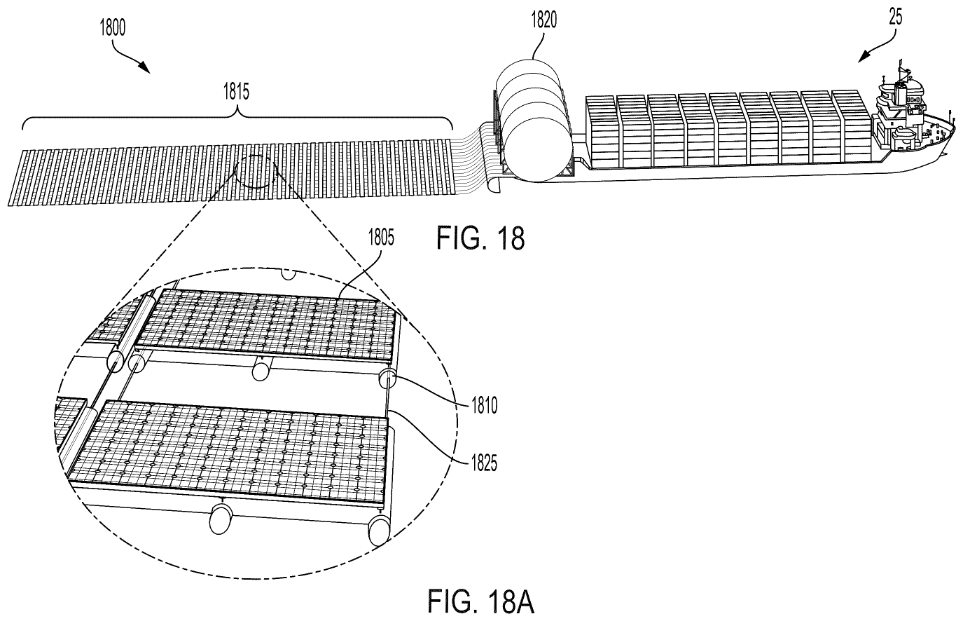

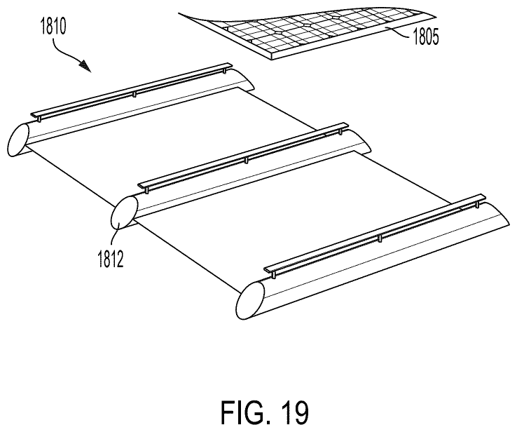

According to another aspect of the embodiments, various types of wheels are disclosed herein for use with an apparatus for collecting solar energy for a marine vessel. The various wheels, and associated structures, used throughout the apparatus can be configured to support a substantial amount of weight and maintain their form. In some embodiments, for example, base structure wheels 320 (FIG. 13) and rolling beam wheels 150 (FIG. 11) can be made of cast iron, but a more malleable material such as steel or aluminum is also feasible if the mechanical properties allow.

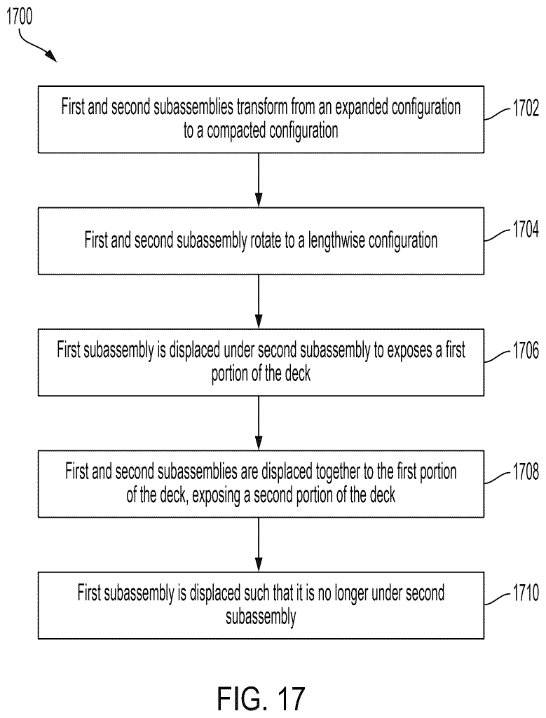

According to another aspect of the embodiments, various types of panel support elements are disclosed herein for use with an apparatus for collecting solar energy for a marine vessel. The various elements which support a solar array, which make up the various panel sections 70 (FIG. 10A) which form the panel structures 60 (FIG. 11), are likely to need less strength and need to be lighter than other pieces of the apparatus. In some embodiments, for example, some panel support elements, such as support piece 80 (FIG. 10B), metal frame 110 (FIG. 10A), and various rolling beams 140, 170 (FIG. 11) can be made of aluminum or fiberglass composites. In other embodiments, the panel support elements can be made out of steel, if cost is a more significant factor than weight.

According to another aspect of the embodiments, various types of gear elements are disclosed herein for use with an apparatus for collecting solar energy for a marine vessel. For example, large gear 240 (FIG. 8), as well as any other gears and moving elements used in the construction of the apparatus can be made of a steel or aluminum alloy material, or titanium, for their precision and durability properties.

According to another aspect of the embodiments, various types of ball bearings are disclosed herein for use with an apparatus for collecting solar energy for a marine vessel. According to one aspect, ball bearings are configured to maintain their form to ensure they mechanically perform. In some embodiments, for example, the ball bearings can be made of iron for strength. In some embodiments, ball bearings can be made of steel, which can have anti-corrosion properties, and which may be desirable depending on the requirements of the vessel.

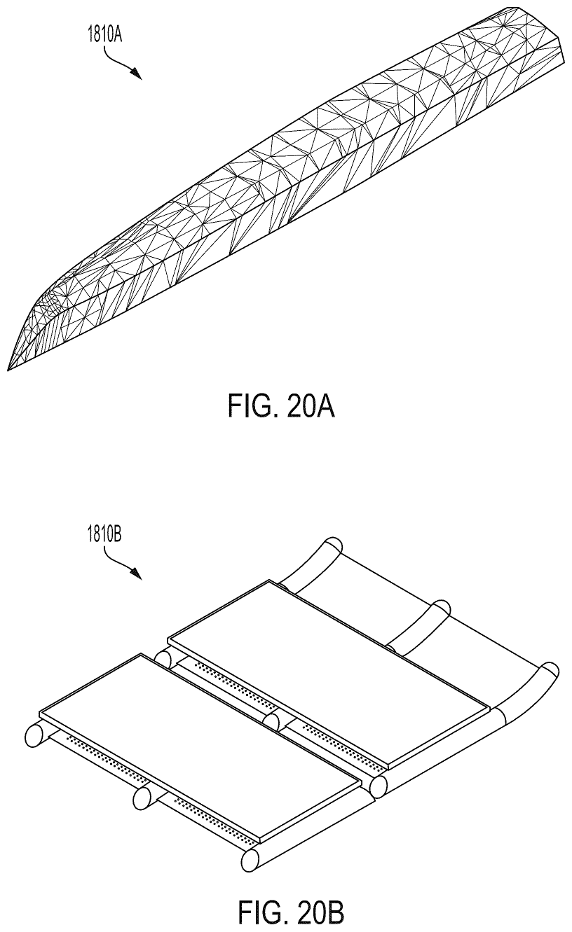

According to another aspect of the embodiments, various types of base structure elements are disclosed herein for use with an apparatus for collecting solar energy for a marine vessel. For example, elements of the base structures 280, 290 (FIGS. 13, 14), can include frame 330, standoffs 340, and rail supports 300, which can be made out of iron, steel, or aluminum. In some embodiments, a combination of materials can also be used for different pieces of the structure. For example, standoffs 340 can be made of steel, while frame 330 and rail supports 300 can be made of aluminum or fiberglass composites. Those of skill in the art will recognize that other combinations can be used and are within the scope of the present disclosure.

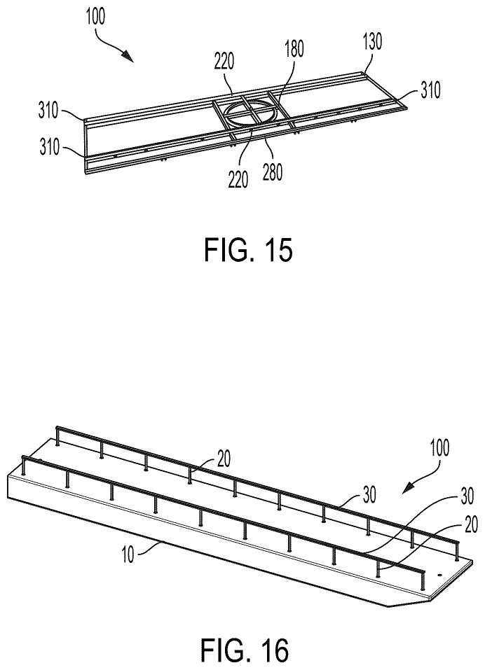

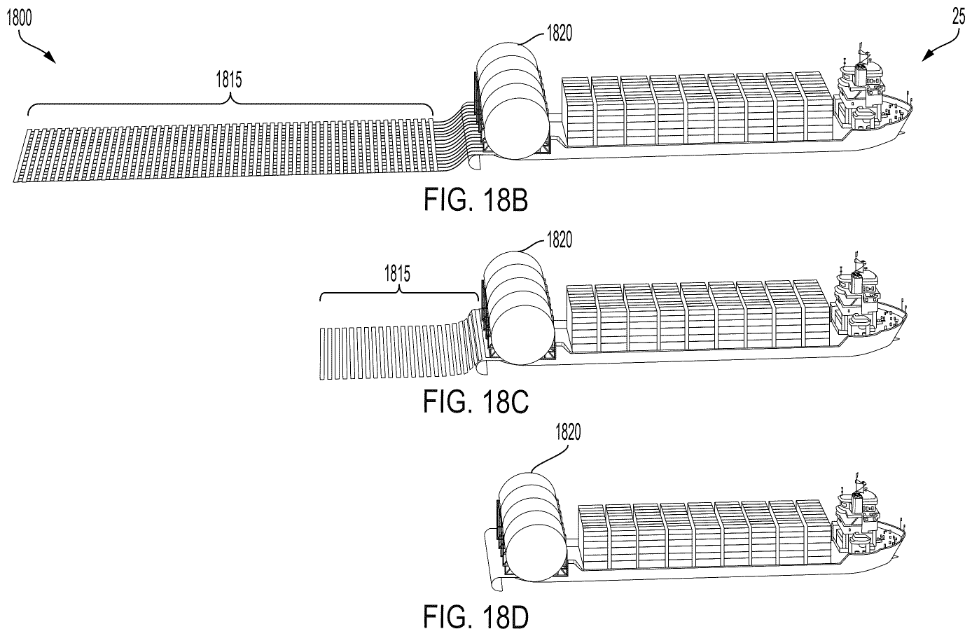

According to another aspect of the embodiments, various types of fixed supporting elements are disclosed herein for use with an apparatus for collecting solar energy for a marine vessel. Fixed supporting elements can include, for example, rail support structure 210 (FIG. 8), base structure of rotating piece 230, support beam 20 (FIG. 2), connecting piece to super-structure 260 (FIG. 9), ring of holder 270, rolling beam support 130 (FIG. 12), other pieces of the rotating piece 190 (FIG. 8), and other pieces of fixed piece 200 (FIG. 8). According to one aspect, these elements can be configured to maintain the structural integrity of the apparatus and require a strong material. Other desirable properties can include, but are not limited to, being lightweight or non-corrosive. In some embodiments, the fixed supporting elements can be made of iron, steel, aluminum, fiberglass composites, or any of the materials previously described with respect to the hull.

According to another aspect of the embodiments, various types of solar panels are disclosed herein for use with an apparatus for collecting solar energy for a marine vessel. In some embodiments, solar panels can include componentry not related to harvesting energy, such as, for example, an aluminum frame or glass covering of the solar cells. Furthermore, in many embodiments, solar panels can comprise any one or more of the following energy-harvesting materials: Monocrystalline Silicon (Mono-Si) Panels, Polycrystalline Silicon (Poly-Si) Panels, Thin-Film Solar Panels, Bifacial Solar Panels, Concentrated Photovoltaic (CPV) Panels, Organic Solar Panels (OPV), Perovskite Solar Panels, Quantum Dot Solar Panels, Transparent Solar Panels, Hybrid Solar Panels, Dye-Sensitized Solar Panels, Nanowire Solar Panels, Flexible CIGS Solar Panels, 3D Solar Panels, and Nanoparticle Solar Panels.

According to another aspect of the embodiments, various types of batteries are disclosed herein for use with an apparatus for collecting solar energy for a marine vessel. In some embodiments, the batteries used to store solar energy from the panel array or other alternative sources of power may be made of many different materials. Some possible types of batteries include, but are not limited to, the following: Lithium-Ion Batteries, Lithium Iron Phosphate (LiFePO4) Batteries, Lithium-Polymer Batteries, Solid-State Batteries, Sodium-Ion Batteries, Flow Batteries, Zinc-Air Batteries, Graphene-Based Batteries, Magnesium-Ion Batteries, Aluminum-Ion Batteries, Lithium-Sulfur Batteries, Nickel-Cadmium (NiCd) Batteries, Nickel-Metal Hydride (NiMH) Batteries, Lithium-Titanate Batteries, Molten Salt Batteries, Superior Aqueous Electrolyte Batteries, Carbon-Zinc Batteries, Silver Oxide Batteries, Mercury Oxide Batteries, Lead-Acid Batteries, Advanced Lead-Acid Batteries, Zinc-Carbon Batteries, Nickel-Zinc (NiZn) Batteries, Hydrogen Fuel Cells, Liquid Metal Batteries, Lithium-Silicon Batteries, Graphite-Aluminum Batteries, High-Temperature Batteries, Quantum Batteries, Copper Foam Batteries, Silicon-Air Batteries, Bismuth-Oxygen Batteries, Polysulfide Flow Batteries, Cobalt-Free Lithium-Ion Batteries, Zinc-Hybrid Batteries, Flexible Printed Batteries, Carbon Aerogel Batteries, Self-Charging Batteries, and Sustainable Organic Batteries.

According to another aspect of the embodiments, certain materials, and their variants and alloys, can be used for multiple components of an apparatus for collecting solar energy for a marine vessel.

In some embodiments, certain variants of steel have desirable mechanical and anti-corrosive properties and can be used for manufacturing various components of an apparatus for collecting solar energy for a marine vessel. These variants include, but are not limited to carbon steels (low, medium, high, and plain), alloy steels (carbon as well as or instead of a variety of other elements), and stainless steel (including but not limited to ferritic, austenitic, martensitic, duplex alloys). Additionally, in some embodiments, different steels may be altered to improve upon, or to attenuate, certain properties of the material.

In some embodiments, certain variants of aluminum can be used for manufacturing various components of an apparatus for collecting solar energy for a marine vessel. Aluminum and its alloys and variants offer a wide range of mechanical advantages, the principle among them being aluminum's strength-to-weight ratio. These variants can include, but are not limited to, pure aluminum, Magnalium, Zamak, Alclad materials, and others.

In some embodiments, certain variants of iron can be used for manufacturing various components of an apparatus for collecting solar energy for a marine vessel. In some embodiments, for example, components of the apparatus for collecting solar energy for a marine vessel can be made of wrought iron, cast iron, or the iron alloy, steel.

In some embodiments, certain variants of titanium can be used for manufacturing various components of an apparatus for collecting solar energy for a marine vessel. In some embodiments, for example, components of the apparatus for collecting solar energy for a marine vessel can be made commercially pure titanium of grades 1-4, along with the following alloys: Ti 6AL-4V, Ti 6AL ELI, Ti 3Al 2.5 and Ti 5Al-2.5Sn. Titanium has high corrosion resistance and light weight, making it a reasonable choice for components of the apparatus which require precision.

### Example Embodiments of Apparatuses for Collecting Solar Energy for a Marine Vessel

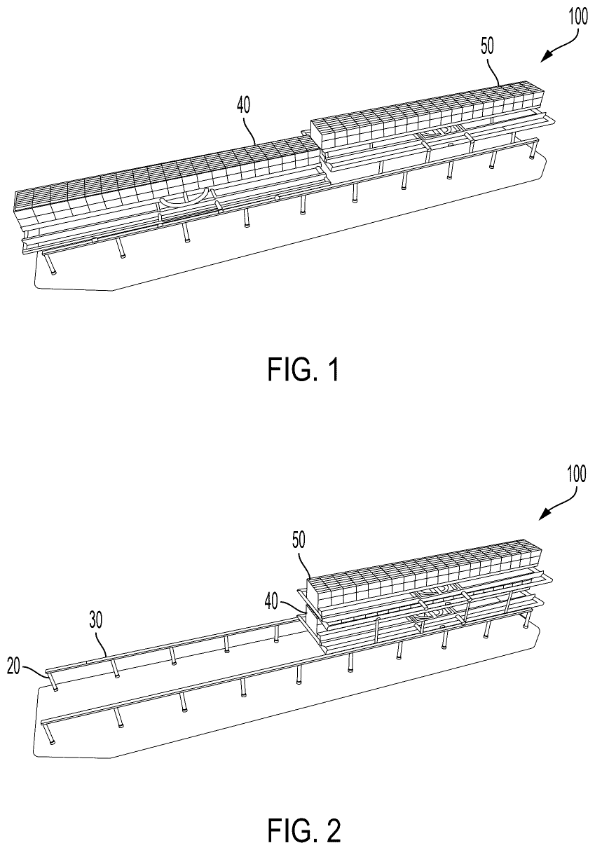

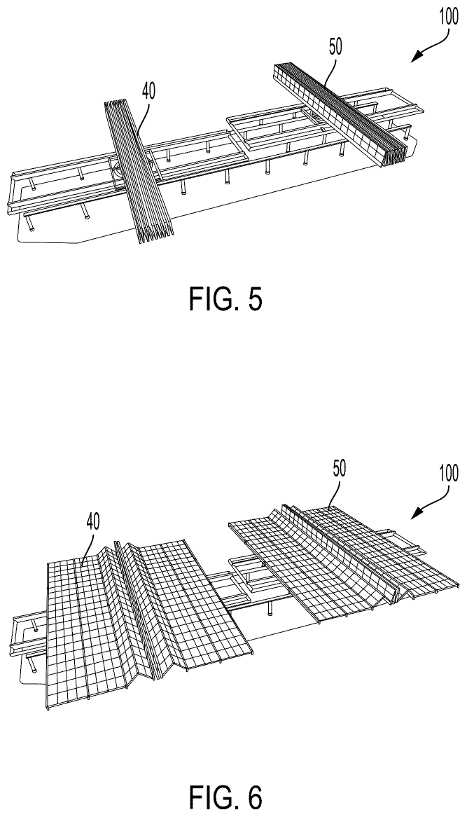

Example embodiments of apparatuses for collecting solar energy for a marine vessel will now be described. Generally, as depicted in FIG. 1, a foldable and rotatable solar panel apparatus 100 is provided, comprising two subassemblies 40, 50 each mounted on opposite sides of a marine vessel's top deck 10, as shown in FIG. 3. In many embodiments, apparatus 100 can be constructed with durable materials capable of withstanding marine environments.

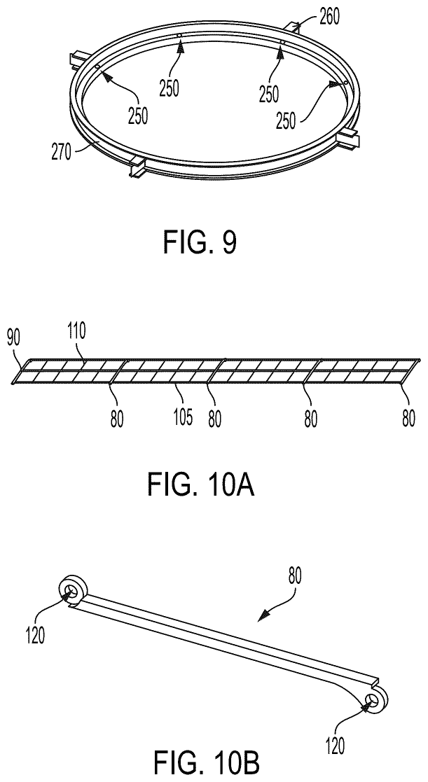

According to one aspect of the embodiments, apparatus 100 is capable of expanding the available surface area available for solar exposure of a marine vessel beyond the initial boundaries of the vessel, as depicted in FIGS. 1 and 4-7. Furthermore, apparatus 100 is also capable of allowing for the top-loading of cargo via a retractable mechanism, as depicted in FIGS. 2 and 3, wherein apparatus 100 can be transformed into a compacted configuration. According to many embodiments, apparatus 100 is capable of movement along at least two axes. Specifically, as viewed from the water line viewing the side profile (where the vessel is parallel with an x-axis) of the vessel with apparatus 100 mounted on top, the two subassemblies 40, 50 of apparatus 100 are capable of rotation along the z-axis, as shown in FIGS. 1, 4, and 5, and translational motion along the x-axis, as shown in FIGS. 1, 2, and 3.

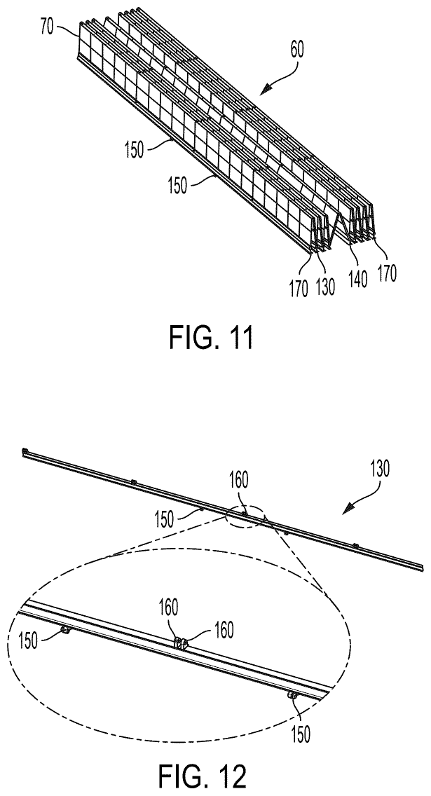

According to another aspect of the embodiments, during operation of the marine vessel, apparatus 100 can be completely extended into an expanded configuration. In some embodiments, for example, a plurality of panel sections 70 (e.g., twelve panel sections, sixteen panel sections, twenty panel sections, etc.) of apparatus 100 are fully extended to lay flat (FIG. 7) defining a substantially planar surface. In some embodiments, panel sections 70 lay parallel to the deck 10 of the vessel but need not be at all times during operation. The entire apparatus 100, pieces of the apparatus, multiple panel sections 70, an individual panel section 70, or individual panels may tilt during operation of the vessel to optimize sun exposure in different climatic conditions.

According to another aspect of the embodiments, apparatus 100 can be re-configured to allow for top-loading and unloading of cargo via a crane or other port infrastructure. As described earlier, in many embodiments, apparatus 100 is configured to move along at least two axes. For example, during loading and/or unloading, apparatus 100 can first complete a folding motion, accordion in nature, followed by a rotational motion, to bring the entirety of the solar array within the bounds of the deck profile of the vessel. At this point, one piece of the apparatus moves beneath another, as shown in FIGS. 2 and 3, to expose at least a portion of the vessel's deck and/or cargo area for loading and unloading. In many embodiments, apparatus 100 can be displaced into various configurations to expose different portions of the vessel's deck and/or cargo space at different times, such that the vessel can be top-loaded and/or unloaded with cargo as required.

Furthermore, according to many embodiments, apparatus 100 comprises individual panel sections 70, as shown in FIG. 10A. In some embodiments, for example, each panel section 70 can have a “long” side 105 and a “short” side 90. Those of skill in the art will appreciate that other relative dimensions are possible and within the scope of the present disclosure. Moreover, in many embodiments, each panel section 70 comprises a metal or composite material frame 110 configured to support and secure the solar panels that cover panel section 70. According to one aspect of many embodiments, metal or composite material frame 110 can be connected to the rest of the apparatus 100 via one or more support pieces 80, which secure to apparatus 100 parallel to “short” side 105. According to another aspect of many embodiments, the support pieces 80 extend beyond frame 110 enough to allow for rotation of each panel section 70 about an axis parallel to “long” side 90 of panel section 70 running through the center of the pivot point 120 at an end of support piece 80, as depicted in FIGS. 10A and 10B.

Furthermore, according to many embodiments, panel sections 70 are coupled together to form panel structure 60, as depicted in FIG. 11. In some embodiments, disposed at a base of panel structure 60 are support rolling beams 130, 140. According to one aspect of many embodiments, beams 130, 140 can be configured to roll on a perpendicular rail-like structure 310 (as seen in FIG. 15), which sits parallel to the deck 10 of the marine vessel and is coupled with either base support structure 280, 290 of apparatus 100 (as seen in FIGS. 13, 14), or on rails 220 on rotation piece 190 of rotational mechanism 180, (as seen in FIG. 8).

In many embodiments, wheels 150 disposed on beams 130, 140 (as seen in FIGS. 11, 12) can resemble those of a rail car or rollercoaster, and are capable of being locked in place such that apparatus 100 can act as a single rigid body. In addition, as seen in FIGS. 10B and 12, for each support piece 80 on the panel sections 70, a rolling beam 130, 140 will have a pivot point 120, 160. Accordingly, all panel sections 70 can be mounted at one end to a support rolling beam 130 at a pivot point 120, 160 to allow for rotation of panel section 70. Further, the other end of the panel section 70 is connected to another panel section 70. Thus, the panel sections 70 are able to rotate relative to each other from the pivot point 120 at which they are connected. When all panel sections 70 are connected in this manner, what results is a large, connected mechanism where there can be one rolling beam 130, 140 for every panel section 70, and connections between panel sections 70 alternate between involving a rolling beam 130, 140 and/or not having a rolling beam 130, 140. Those of skill in the art will appreciate that some embodiments can comprise one rolling beam for a plurality of panel sections. Likewise, other embodiments can comprise a plurality of rolling beams for each panel section. As depicted in FIG. 11, panel sections 70 at either end of the vessel are mounted to a rolling beam without other panel sections 70 being mounted to the same rolling beam 170.

In another aspect of the embodiments, as seen in FIG. 11, a center rolling beam 140 is provided. This beam 140 has an equal amount of parallel rolling beams in one direction and the other. According to many embodiments, however, the center beam 140 is not on wheels, but rather is coupled with the rotating piece 190 of the rotational mechanism 180.

According to another aspect of many embodiments, the rotational functionality of apparatus 100 can be attributed to rotational mechanism 180, shown in FIGS. 8 and 9. In many embodiments, rotational mechanism 180 comprises a rotating piece 190 and a fixed piece 200. In some embodiments, fixed piece 200 is coupled with base structures 280, 290 by a plurality of steel pieces 260 and comprises of an open ring-like cylinder 270 with two levels of protrusions, an inner level which supports ball bearings 250 to allow for rotation of the rotating piece 190, and an upper level to ensure the rotating piece 190 remains in position. In addition, rotation piece 190 of rotational mechanism 180 comprises three layers. The first layer is a hollow cylinder piece 230 with a complimentary shape to fixed piece 200. This piece is in contact with ball bearings 250 and is configured to rotate freely. A second layer is a gear 240 which can be a hollow cylinder with the same inner diameter as the first layer. In some embodiments, the teeth of gear 240 do not protrude. In this regard, gear 240 is configured to enable the rotating of rotating piece 190 and is driven by a smaller gear attached to a motor which can be affixed to base structure 280, 290. The final layer of rotating piece 190 is a square steel superstructure 210, which is configured to support the rails 220 and provide attachment points for center rolling beam 140. In many embodiments, as seen in FIG. 8, corners of square superstructure 210 are configured to allow for the rotation of rotating piece 190 such that rails which the rolling beams are on may line up as flush as possible.

In many embodiments, base structure 280, 290 is a steel superstructure, wherein each base structure supports a rotational mechanism 180 and a panel structure 60. In some embodiments, flush with the rotating piece 190 of the rotational mechanism 180 are four steel or composite material beams with rails mounted parallel on top of them. The beam/rail structures are coupled with the base structure 280, 290 in an alignment such that the rails on the rotating piece 190 of the rotational mechanism 180 are aligned when the rotational mechanism 180 is in an “0-degrees” orientation. This allows for the rolling beams on the panel structure 60 to move from the compacted position, where they are supported by the rails of the rotational mechanism's 180 rotating piece 190, to be partially or completely supported by the beam/rail structures coupled with base structure 280, 290. This movement happens during apparatus 100 expanding and compacting.

Referring next to FIGS. 13 and 14, base structure 280 and 290 are depicted. In some embodiments, base structure 290 is slightly wider than base structure 280, which can include wheels 320 coupled with the base support structure facing the opposite direction to allow for the rails to be closer in position. In many embodiments, base structure 290 can further be configured to extend the base of the structure, which panel section 60 and rotational mechanism 180 operate on, in an up-and-down direction (e.g., along a y-axis). In some embodiments, this can be done with a hydraulic or actuarial mechanism in legs 340 coupling the base of the structure 290 with wheels 320. In some embodiments, base structure 290 can extend up along the y-axis such that the first subassembly 40 has enough clearance to slide completely under the second subassembly 50, as shown in FIGS. 2 and 3

According to another aspect of some embodiments, as depicted in FIGS. 2 and 3, both base structures 280 and 290 are situated on rails 30. In some embodiments, each base structure can have its own set of rails 30, which are parallel to each other and the length of the vessel, and which are disposed at a predetermined height above the deck 10 of the vessel such that cargo can appropriately be stored beneath either base structure. Furthermore, base structures 280 and 290 can each move along an x-axis along the length of the vessel, as shown in FIGS. 2 and 3. According to some embodiments, base structures 280 and 290 can move alone or together to meet the specific requirements at the time of operation. According to many embodiments, second subassembly 50 can be configured to move over the first subassembly 40, when necessary, in a manner reminiscent of a car sliding into a garage.

### Example Embodiments of Apparatus Folding Mechanisms

FIG. 7 depicts apparatus 100 in an expanded configuration, where all panels are fully expanded and the face of each panel is parallel to the deck of the vessel. In this position, the total surface area of the solar panels is maximized.

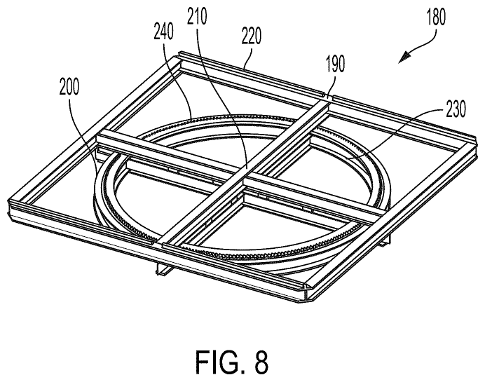

According to many embodiments, apparatus 100 can be configured to fold in an “accordion” motion into a compacted configuration. Referring to FIG. 11, in some embodiments, each rolling beam 130, 170 can be configured to move in closer toward center rolling beam 130. As this happens, each rolling beam becomes closer to the neighboring rolling beams. As two rolling beams move closer, the pivot point 120 connecting the panel sections attached to the two rolling beams moves up along the y-axis. Rolling beams can have multiple winches and cables connected each rolling beam to its two neighboring rolling beams—except for end rolling beam 170, which has a winch connecting it to its neighbor and the end of the apparatus half support structures 280, 290. According to some embodiments, to bring the panel sections from an expanded configuration (as shown in FIG. 7) to a compacted configuration (as shown in FIG. 5), the winches between rolling beams are pulled in, bringing each rolling beam closer together. To go the opposite direction, the winches which are connected to the end rolling beams 170 and support structure 280, 290 are wound in, causing rolling beams 130, 170 to spread further apart as each panel section expands to lie flat. Before and after each motion the locking mechanism on the wheels of the rolling beams 150 are locked to ensure safe operation of the vessel.

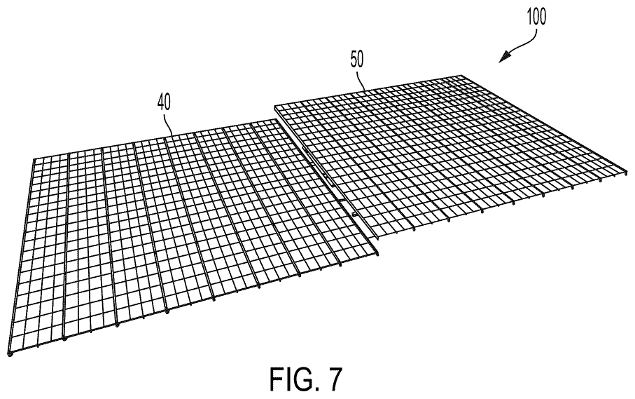

In some embodiments, the range of position for the folding mechanism has an extended limit which is near, exactly, or beyond the length of the vessel, as shown in FIG. 7. The compacted limit of apparatus 100 occurs when the support rolling beams are closest (FIG. 5), and each panel structure 60 has its wheels 150 within the bounds of the rails 220, which lie on rotation piece 190 of rotational mechanism 180. During rotation, apparatus 100 can be in a compacted configuration, as shown in FIGS. 4 and 5.

### Example Embodiments of Apparatus Rotational Mechanisms

According to another aspect of many embodiments, each half of apparatus 100 is capable of rotation as described with respect to rotational mechanism 180. In one aspect, rotation occurs after the folding of apparatus 100 or prior to expansion of apparatus 100. In other words, in many embodiments, apparatus 100 is not configured to rotate and fold and/or expand at the same time.

Furthermore, according to another aspect of many embodiments, apparatus 100 is capable of 360 degrees of rotation. However, for practical purposes only 90 degrees of rotation (as shown in FIGS. 1, 4, and 5) are necessary. Apparatus 100 may rotate between an expanded configuration (FIG. 5) where the rolling beams are perpendicular to the length of the vessel's deck and a compacted configuration (FIG. 3) where the rolling beams are parallel to the length of the vessel's deck.

### Example Methods for Cargo Loading and Unloading

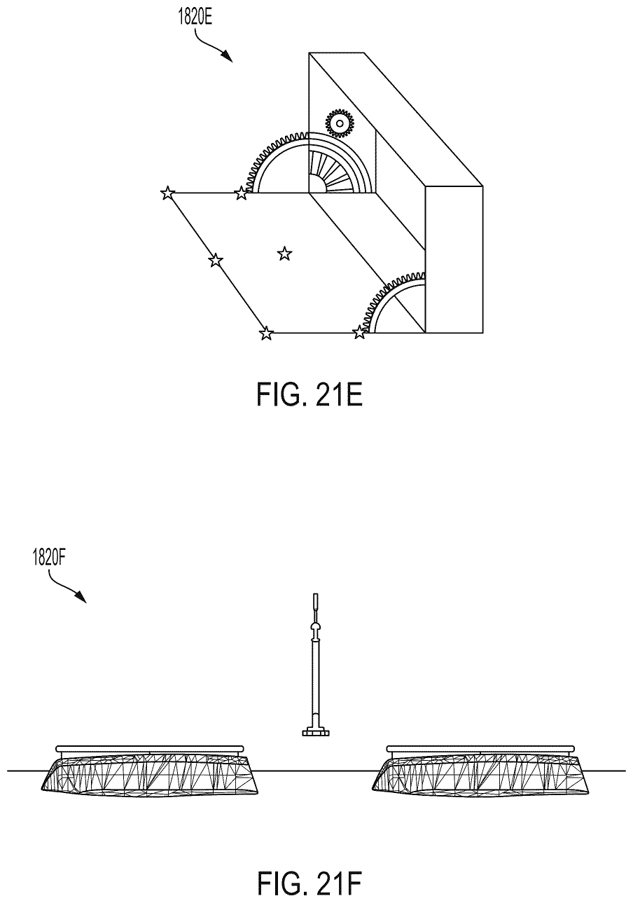

FIG. 17 depicts a method 1700 for cargo loading and unloading to be utilized with an apparatus 100 for collecting solar energy for a marine vessel, as described herein. According to an aspect of the embodiments, when a vessel equipped with the apparatus 100 approaches a port, it is often the case that the fully expanded apparatus 100 would make the vessel too broad to dock. For this reason, prior to approaching the port each half of the apparatus will first fold and then rotate. In particular, at Step 1702, the first and second subassemblies of apparatus 100 are transformed from an expanded configuration to a compacted configuration, such that the panel structures are folded, rolled, or otherwise in a compacted state, as shown in FIG. 7 to FIG. 5. Next, at Step 1704, the first and second subassemblies of apparatus 100 are rotated to a lengthwise configuration, as shown in FIG. 5 to FIG. 4 to FIG. 1. In many embodiments, the rotation can be a ninety degree rotation.

Now that the complete panel structure is within the profile of the vessel, the vessel may approach the dock. Once docked, half of the apparatus will come beneath the other half to reveal half of the deck space of the vessel. In particular, at Step 1706, the first subassembly is displaced under the second subassembly, exposing a first portion of the vessel's deck.

After unloading/loading the first side, both halves of the apparatus move to a position such that they reveal the other half of the vessel's deck. In particular, at Step 1708, first and second subassembly are displaced together to the first portion of the deck, exposing the second portion of the deck. Once the vessel has completed its port activities, the two halves of the apparatus are returned to their original positions. In particular, at Step 1710, first subassembly is displaced such that it is no longer under the second subassembly. The vessel can then exit the port and allow each half of the apparatus to rotate then extend out once the vessel is a safe enough distance from the port to do so.

### Example Embodiments of Trailing Apparatuses for a Marine Vessel

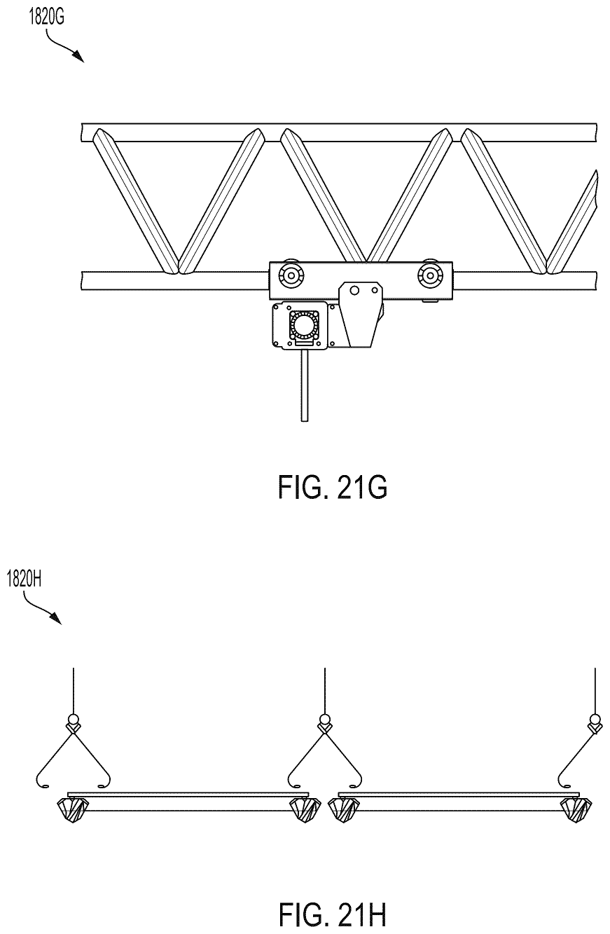

According to another embodiment, solar panels can be configured to be trailed behind a marine vessel, allowing for a significant increase in the surface area available for solar energy collection without occupying the valuable deck space of the marine vessel. FIGS. 18 and 18A depict an example embodiment of a trailing apparatus 1800. According to said embodiment, trailing apparatus 1800 can include a trailing platform 1815. In many embodiments, as depicted in the call-out of FIG. 18A, the trailing platform 1815 can comprise a series of interconnected and/or selectively unconnected solar panel modules 1805. Said modules 1805 can further be coupled with and deployed on floating structures (e.g., skids) 1810, which are operatively tethered to the stern of ship 25. The floating structures or skids 1810 can be designed to be low drag via various mechanisms. According to an aspect of the embodiments, trailing platform 1815 is engineered to remain stable in various sea conditions, utilizing a combination of buoyancy aids and dynamic stabilization systems to maintain a target panel orientation relative to the sun. Furthermore, trailing platform 1815 can be connected to the marine vessel via a robust cable system that allows for both electrical transmission and mechanical stability.

According to another aspect of the embodiments, trailing platform 1815 can be either retractable or permanent. In some embodiments, for example, during adverse weather conditions or when docking, trailing platform 1815 can be retracted and secured to the ship's hull or on the vessel using a winch mechanism 1820, ensuring the safety and integrity of solar panels 1805, as seen in FIGS. 18B, 18C, and 18D. This approach is advantageous for solar energy capture and also reducing interference with a ship's operational activities, among other reasons.

### Example Embodiments of Panel Collision Prevention Techniques

With respect to trailing apparatus 1800, one problem to be addressed is the prevention of unwanted movement of solar panels 1805 when deployed. Said unwanted movement can include, for example, lateral collisions, misalignment, tangling, or flipping of adjacent rows. To address this problem, rubber buffers can be installed between panel sections to absorb impact forces during lateral collisions. In some embodiments, non-rigid connections such as steel cables can link some or all panel sections, allowing panels 1805 to maintain flexibility while preventing them from drifting too far apart. In some embodiments, magnets can create magnetic connections to keep the panel sections aligned. Those of skill in the art will recognize that these solutions (and other similar solutions) can be implemented either alone or in combination with one or more other solutions.

Additionally, according to some embodiments, rigid connections between rails can ensure that panels 1805 move as a single unit. In some embodiments, a latch and/or hinge mechanism can connect panels 1805, allowing them to move together while providing some degree of flexibility. In some embodiments, floating barriers between rows of panels 1805 can prevent them from overlapping or tangling. Further, in some embodiments, hydraulic dampers can be installed between panel sections to absorb shocks and prevent misalignment In addition, according to some embodiments, guided tracks can ensure that panels 1805 remain aligned during deployment and retraction. Further, in some embodiments, a tether system can connect each panel section to a central tether, keeping them aligned and preventing excessive movement. Finally, a wave-responsive design using sensors and actuators can dynamically adjust panel positions in real-time, providing active control over alignment.

### Example Embodiments of Skid Configurations

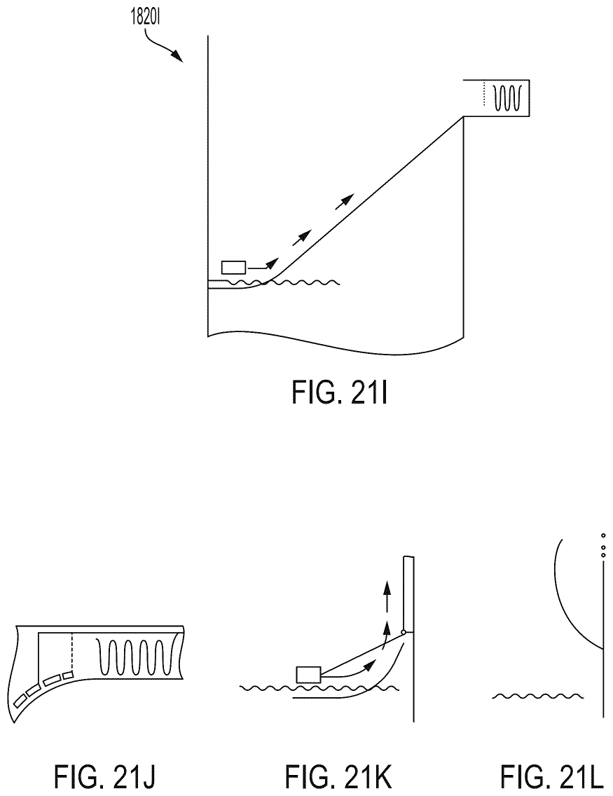

According to another aspect of the embodiments, skids 1810 can be configured to transfer the load from the weight of panels 1805 through the designed frame into the skids. FIG. 19 is a partially exploded view of an example embodiment of skid 1810 and solar panel 1805. Considerations for skid design can include the overall weight, dynamic loads from waves, and a reliable way to connect all of the panels to the ship. The skids are configured to transfer the load from the panel structure to the skid. According to many embodiments, skids 1810 can be manufactured from a material with high strength-to-weight ratios, such as steel, aluminum, and fiberglass, and those that are corrosion-resistant for marine environments. Those of skill in the art will appreciate that other materials can be utilized instead of or in combination with the aforementioned.

According to an aspect of the embodiments, skids 1810 can be configured to enhance buoyancy, reduce drag, and account for dynamic loads from waves (and other marine conditions). In some embodiments, for example, skids 1810 can include shock-absorbing materials and designs to mitigate impact forces. For example, in some embodiments, shock-absorbing designs can comprise spring mechanisms or hydraulic mechanisms. In other embodiments, skids 1810 can include marine foam disposed in an interior of skids 1810. Foam can include, for example, expanding marine foam configured to fill the inside of pontoons 1812 of skid 1810 while accommodating the space around internal structural supports.

In some embodiments, skids 1810 can include a fiberglass outer shell connected to a steel structure using strong adhesives. In some embodiments, skids 1810 can include mounting points that use plates to cap the ends of structural tubing for better adhesive bonding. Adhesive bonding can comprise one or more marine-grade adhesives configured to bond structural components, ensuring flush surfaces for optimal bonding between fiberglass and metal parts.

According to another aspect of the embodiments, trailing platform 1815 can be configured to securely and operatively connect all panels 1805 to the ship and structures, allowing for flexibility and movement without compromising structural integrity. In addition, the height of skids 1810 can be dimensioned to minimize water resistance and maintain stability (e.g., a skid height between eight centimeters and one meter, or a skid height of approximately nine inches), while ensuring that skids 1810 are high enough to avoid submersion in rough seas.

In some embodiments, skid 1810 can include internal support structure comprising steel tubing or other materials (e.g., aluminum or plastic), and which are configured to distribute loads evenly within the skid 1810. In some embodiments, the interior of the skid can be filled with foam. In other embodiments, a plurality of exterior and/or interior walls of the skid can be dimensioned to be thicker the interior and/or exterior walls. In still other embodiments, the exterior structure can be manufactured from a first material and the internal support structure can be manufactured form a second material that is different than the first material, wherein the first material is stronger than the second material. In other embodiments, the interior walls of the skid can be dimensioned to be thicker. According to many embodiments, skid 1810 can be dimensioned such that weight distribution ensures balance and stability. For example, in many embodiments, a variety of hull designs (such as those described herein) may be utilized to assure seaworthiness and stability.

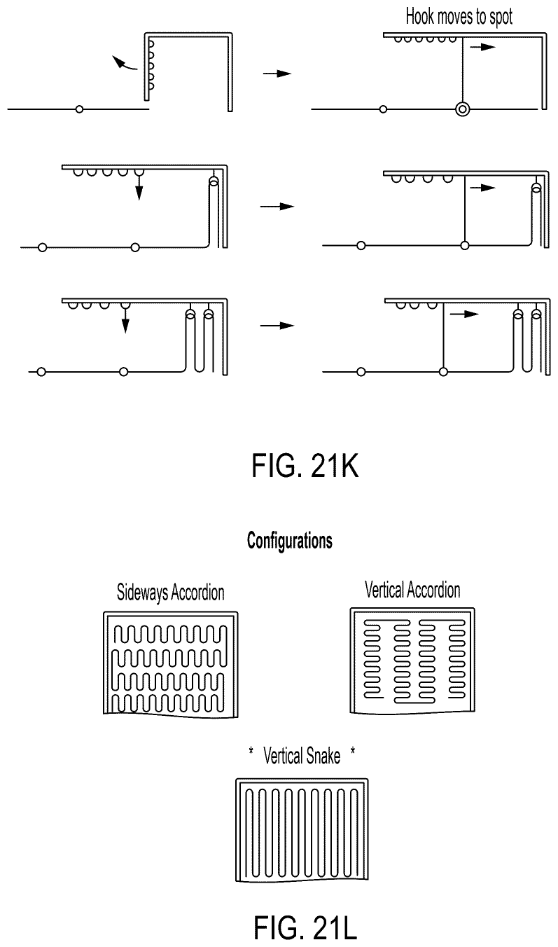

According to another aspect of the embodiments, different skid embodiments can be implemented and will now be described. In some embodiments, skids can comprise a pontoon 1810A, as depicted in FIG. 20A, which provide buoyancy through hollow structures filled with air or lightweight foam to ensure the panels remain afloat. In other embodiments, catamaran-style skids 1810B can also be used, featuring dual pontoons connected by a framework to offer enhanced stability and load distribution, as depicted in FIG. 20B. According to some embodiments, pontoon 1810A can be utilized with the skid 1810B, as depicted in FIG. 20B. In yet another embodiment, hydrodynamic skids are designed with streamlined shapes to minimize water resistance and improve maneuverability. In another embodiment, modular skids can be assembled from multiple interlocking sections, allowing for flexibility in size and configuration. In other embodiments, inflatable skids offer a lightweight and compact storage solution, expanding when deployed to provide buoyancy. In still other embodiments, retractable skids can be extended from the vessel when needed and retracted for storage, minimizing deck space usage. Similarly, in other embodiments, telescopic skids can adjust in length to accommodate different water conditions and panel sizes. In still other embodiments, suspension skids incorporate shock-absorbing materials to manage dynamic loads from waves, ensuring stability and protection for the panels.

With respect to the above-described embodiments, skids can comprise a composite material, such as fiberglass or carbon fiber for strength and reduced weight. In some embodiments, adjustable buoyancy skids can be configured to alter their buoyancy levels using ballast systems to adapt to varying loads and water conditions. In some embodiments, flexible skids can be configured to conform to the water surface, providing stability in rough seas. In some embodiments, anchored skids can be secured to the seabed to prevent drift, ensuring the panels remain in a fixed position. In some embodiments, articulated skids feature joints that allow for movement and flexibility, adapting to wave motion. Those of skill in the art will recognize and understand that the aforementioned embodiments are meant to be illustrative and non-limiting, and that other skid configuration can be utilized with the trailing apparatus to ensure effective deployment and operation of solar panels on water.

### Examples of Wiring Configurations for the Trailing Apparatus

According to another aspect of the embodiments, trailing apparatus 1800 can further include wiring 1825 (as depicted in FIG. 18A) operatively and electrically coupled with the deployed floating panels, wherein wiring 1825 is configured to ensure efficient electricity transmission. To reduce the risk of wiring 1825 becoming taut or damaged during deployment and retraction, trailing apparatus 1800 can be configured to store excess wiring 1825 when panels 1805 are withdrawn using drum-like structures to spool and store wiring 1825 and support cables. According to another aspect of some embodiments, wiring 1825 can include pinch points and minimum bend radius to prevent wire damage. In some embodiments, wiring 1825 can comprise water-resistant coatings to protect wires from fresh and saltwater.

According to another aspect of some embodiments, trailing apparatus 1800 can include combiner boxes or other equipment to safely connect panel strings and minimize the number of wires running to the ship. In this regard, the wiring path can be configured to avoid tangling and ensure smooth deployment and retraction, with wires secured between panels while allowing some give to prevent tension. Furthermore, in some embodiments, manual intervention procedures can be developed to manage wire deployment and retraction, with safety protocols in place, such as turning off power during manual adjustments. According to another aspect of some embodiments, electrical components can be housed on the ship, potentially within the drum 1820, to minimize wire length and complexity. Moreover, in some embodiments, slip rings can be used to allow for wire rotation without twisting and effective energy transmission.

Those of skill in the art will appreciate that wiring 1825 can be dimensioned to a predetermined diameter and utilize materials suitable for marine environments, in order to allow for both flexibility and strength. In some embodiments, wire coating and protection can be utilized with wiring 1825, including double-coated wires for added resistance to water and abrasion, with all connections conforming to marine standards. Further, in some embodiments, wiring 1825 can include harnesses and trunk cables. In addition, in some embodiments, wiring 1825 can be utilized in combination with surge protectors and circuit breakers, as needed, to handle electrical loads and current management. Likewise, monitoring and control systems can be incorporated with wiring 1825 to track wire performance and condition, using automation to optimize deployment and retraction. Moreover, wireless energy transmission may be utilized to transfer energy from the panels to the energy storage system on board the vessel.

### Examples of Storage Systems for Solar Panels on a Marine Vessel

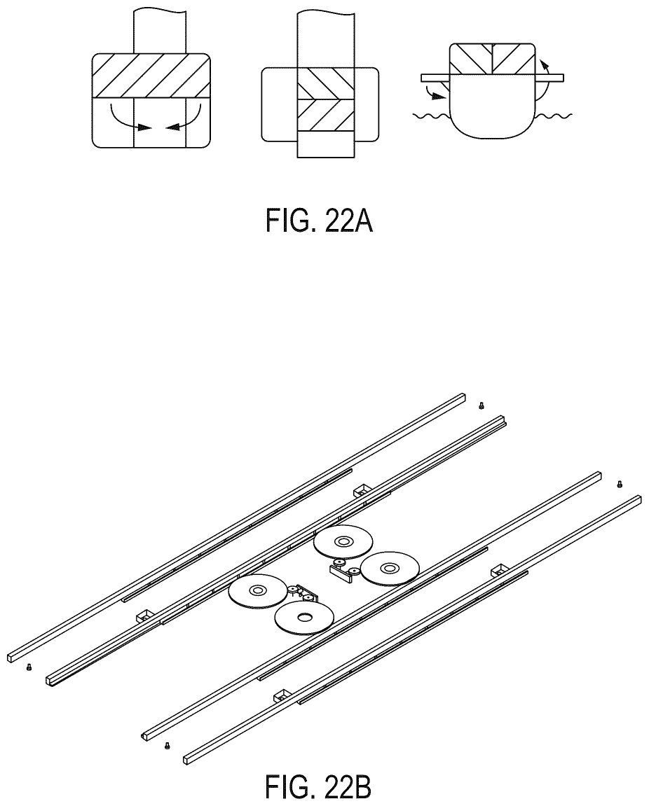

According to another aspect of the embodiments, described herein are storage systems for solar panels on a marine vessel, and various components and features thereof. The panel storage system for marine vessels can be configured to hold the panels securely while ensuring structural soundness and minimizing weight. Furthermore, in some embodiments, the panel storage system can include a washing system to clean panels while stored and maintain an optimal panel angle for space efficiency and structural integrity. In some embodiments, the panel storage system 1820A can include curved storage tracks that are configured to facilitate efficient storage and deployment (FIG. 21A). Said panel storage system can also include an attachment cable that is configured to remain connected during storage and deployment for secure and reliable cable management. The attachment cable, which may incorporate electrical components like wires, may be detached from the skids and panels as part of the deployment & withdrawal process. Moreover, other mechanisms may be used than a cable to connect modules, such as chain link. In this regard, the panel storage system is configured to minimize the volume occupied by the panels by, for example, using a rolling method to optimize space usage. In addition, according to some embodiments, the panel storage system can include a retraction mechanism having a chain and hook feature (e.g., similar to roller coaster mechanisms for reliable retraction), complemented by a track and wheel feature 1820G to guide skids along a predefined path (FIG. 21G). The skids may be connected and unconnected from one another as part of the deployment and withdrawal process, in order to facilitate more effective storage on board the vessel. This connection process may be done automatically, or manually, and can be combined with the various storage configurations outlined.

According to another aspect of the embodiments, the storage systems described herein can include steel truss structures and coated aluminum shields for supporting the load of the panels and protecting against environmental damage. In some embodiments, the storage systems can include inner walls that are configured to separate panel sections, with load-bearing tracks connected to each wall to support skids. Said load-bearing tracks and other wall structures can be configured to distribute forces to ensure effective load support and transfer. In another aspect, the storage systems can comprise steel and aluminum for structural components, with corrosion-resistant materials considered for marine environments.

Further, in some embodiments, the storage system can include a cable system configured to retract and hold a drum 1820A (FIG. 21A), preventing tangling of wiring during retraction and deployment. In some embodiments, for example, drum 1820A can be configured to store the panels in a rolled up state. According to some embodiments, a central housing section accommodates cabling and winch components, using stationary cylinders with multiple cable spools powered by high-power winches. Synchronization of inner winches with the chain system ensures smooth retraction, removing slack and preventing tangling. In some embodiments, the retraction mechanism is dynamic, using an active system to extend and retract panels sequentially.

According to another aspect of the embodiments, to store the panels onboard once they are deployed, several structural options can be considered to ensure efficient and secure storage. FIGS. 21A to 21L depict example embodiments of storage systems for solar panels on a marine vessel. In some embodiments, for example, deck-mounted frames are utilized to provide a stable platform for the panels to rest on when not in use, designed to fold or collapse when the panels are deployed to maximize deck space. In some embodiments, retractable platforms can extend from the ship's sides or stern to provide additional storage space and retract when panels are deployed, reducing drag and maintaining the ship's streamlined profile. In some embodiments, vertical racks can store panels in a stacked configuration, optimizing vertical space and ensuring secure placement and easy access for deployment. In some embodiments, rotating drums 1820A (FIG. 21A) or cylindrical storage systems 1820D (FIG. 21D) can roll the panels into a compact form, minimizing the storage footprint and facilitating smooth transitions between storage and deployment. In some embodiments, modular storage containers can house panels in a protected environment, allowing for easy transport and deployment, and designed to be modular for flexibility and adaptability. In some embodiments, sliding rails can guide panels into designated storage areas, ensuring secure placement and easy access, incorporating stops and locks to secure panels during storage. In addition, in some embodiments, crane systems 1820B (FIG. 21B) can lift and position panels into storage zones, providing flexibility in panel arrangement, using slings or lifting tongs 1820H (FIG. 21H) to secure panels. In some embodiments, hydraulic lifts can raise and lower panels into storage compartments, facilitating smooth transitions and ensuring the hydraulic system can handle the load and operate reliably. In some embodiments, inflatable storage systems can provide cushioning and protection for panels, especially in rough sea conditions, ensuring panels are securely stored and protected from damage. In some embodiments, magnetic docking systems can secure panels in place without the need for mechanical fasteners, allowing for quick deployment and retrieval of panels. In some embodiments, telescoping arms can extend to store panels in a compact configuration and retract when panels are deployed to save space. In some embodiments, automated storage systems can manage the storage and retrieval of panels using automation, incorporating sensors and controls to optimize storage efficiency. In some embodiments, buoyant platforms can store panels on buoyant platforms that can be deployed and retrieved from the water, ensuring platforms are stable and can support the weight of the panels. In some embodiments, sliding rails can guide panels into designated storage areas, ensuring secure placement and easy access, incorporating stops and locks to secure panels during storage. In some embodiments, deployment ramps 1820I (FIG. 21I) can slide panels into storage areas, ensuring ramps are strong enough to support the weight and provide a smooth transition. In some embodiments, deployment cradles can hold and store panels in cradles that can be easily deployed and retrieved, using pivot points or hinges to control the movement of the cradles. In some embodiments, flexible storage systems can adapt to different storage conditions using adjustable components, ensuring the system can operate reliably in different marine environments. Those of skill in the art will readily appreciate that any one or more of the embodiments described above can be utilized alone or in combination with another one or more of the embodiments described above.

### Examples of Storage Translation Systems

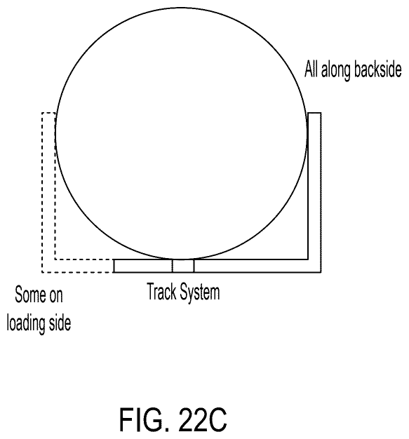

According to another aspect of the embodiments, a storage translation system for marine vessels can be configured to facilitate the efficient and stable movement of the structure containing solar panels, allowing for seamless loading and unloading while promoting stability in both translated and untranslated states. In some embodiments, the storage translation system can be configured to accommodate various translation mechanisms, such as winches, rack and pinion systems, and gear rotations. Furthermore, in some embodiments, a storage translation system can be configured to such that the drum can translate in both directions without compromising cargo capacity or vessel stability. In some embodiments, the storage translation system can include support structures configured to manage the load when the drum is cantilevered over the edge of the marine vessel. For example, in some embodiments, said support structures can include retractable supports or suspension-inspired mechanisms. Said storage translation systems can be further configured to prevent the drum from rolling or becoming unstable, and can further be configured to be adaptable, allowing for the integration of different translation technologies while maintaining structural integrity and operational efficiency. Various translations may be considered, including designs that take into account rotation. FIG. 22A diagrammatically depicts various potential storage translation movements, showing how a storage container that may expand beyond the width of the ship can be translated to fit within the width of the ship at times where it is useful (like loading or unloading). FIG. 22B depicts an example mechanism for moving the storage container, utilizing motors, gears, and tracks. FIG. 22C depicts a stabilization system configured to provide support to the storage container as the ship rolls and pitches.

### Examples of Deck Extensions

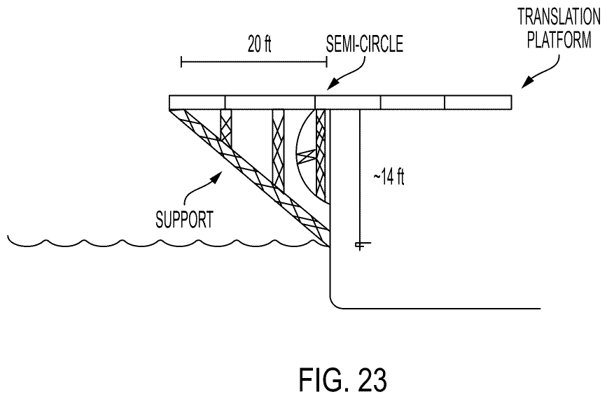

According to another aspect of some embodiments, a deck extension for maximizing the deck area for storing solar panels will now be described. According to some embodiments, the deck extension can be configured to provide additional space on the vessel, allowing for more efficient storage and deployment of solar panels. In some embodiments, for example, the deck extension can be designed to integrate seamlessly with the existing structure of the ship, ensuring stability and structural integrity. Various materials, such as steel or aluminum, can be used to construct the deck extension. In many embodiments, the deck extension can be further configured to withstand marine conditions, including dynamic loads from waves and wind. The deck extension can also include features such as support beams, retractable elements, and modular components to enhance flexibility and adaptability. The extension can be equipped with mechanisms to facilitate the deployment and retraction of solar panels, ensuring smooth operation. By implementing a deck extension, the vessel can achieve greater storage capacity for solar panels, improving the efficiency and effectiveness of solar energy collection on marine vessels. FIG. 23 depicts an example embodiment of a deck extension, which includes diagonal and vertical support beams to transfer load from the deck extension to the hull of the vessel, and a semi-circle to aid in the deployment of the panel trail.

### Example Embodiments of Deployment/Withdrawal Mechanisms

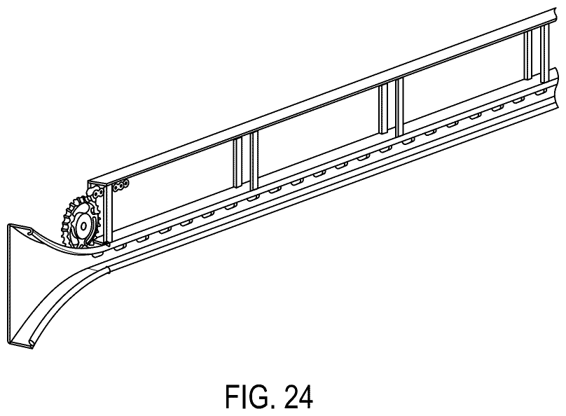

Example embodiments of mechanisms for deploying panels from the ship to the water will now be described, wherein the embodiments are configured to ensure efficiency, reliability, and safety. In some embodiments, a deployment/withdrawal mechanism can include cable and winch systems, which can further include steel cables and winches to control the deployment speed and tension, ensuring the cables are strong enough to handle the load of the panels. In other embodiments, a deployment/withdrawal mechanism can include chain systems that comprise heavy-duty roller chains with hooks and/or attachment points to secure the panels during deployment. In still other embodiments, a deployment/withdrawal mechanism can include a rack and pinion system (FIG. 24), which can further include a gear and a straight version of the gear to translate panels smoothly.

According to some embodiments, deployment/withdrawal mechanisms can include rotating mechanisms, where a rotating structure pivots the panels from the ship to the water, supported by bearings and supports for smooth operation. In other embodiments, deployment/withdrawal mechanisms can include hydraulic systems comprising hydraulic arms and/or pistons to lower panels, controlled by hydraulic mechanisms to manage deployment speed and positioning. In still other embodiments, deployment/withdrawal mechanisms can include guided track systems configured to use tracks to direct panels and incorporate rollers or wheels to minimize friction. In other embodiments, deployment/withdrawal mechanisms can include conveyor belt systems configured to transport panels using conveyor belts, supported by structures to maintain alignment and stability. In other embodiments, deployment/withdrawal mechanisms can include crane and hoist systems that are configured to lift and lower panels using cranes or hoists, secured by slings or lifting tongs. In still other embodiments, deployment/withdrawal mechanisms can include telescoping arms that are configured to extend to deploy panels, with locking mechanisms to secure the arms. In some embodiments, deployment/withdrawal mechanisms can include modular deployment platforms that extend from the ship to the water, and which utilize retractable or folding designs to save space.

In still other embodiments, deployment/withdrawal mechanisms can include automated systems that are configured to control the deployment process using sensors and automation. In some embodiments, deployment/withdrawal mechanisms can include buoyant platforms that are configured to float panels from the ship to the water, controlled by tethers or guide ropes. In other embodiments, deployment/withdrawal mechanisms can include sliding rails that are configured to guide panels using the rails, incorporating stops and locks for security. In some embodiments, deployment/withdrawal mechanisms can include deployment ramps that are configured to slide panels using ramps, with rollers or low-friction surfaces to facilitate movement. In some embodiments, deployment/withdrawal mechanisms can include deployment cradles that are configured to hold and deploy panels using pivot points or hinges. Those of skill in the art will readily appreciate that any one or more of the embodiments described above can be utilized alone or in combination with another one or more of the embodiments described above.

### Examples Embodiments of Panel Washing Systems

Example embodiments of panel washing systems will now be described. According to an aspect of the embodiments, panel washing systems can be implemented to ensure the efficient and thorough cleaning of solar panels on marine vessels. In some embodiments, panel washing systems can include automated brush systems that are configured to use rotating or oscillating brushes mounted on a track or robotic arm to cover the entire panel area, effectively removing dirt and debris. In other embodiments, panel washing systems can include water spray systems that are configured to employ high-pressure water jets to clean the panels, often integrated with a recycling system to minimize water waste. In still other embodiments, panel washing systems can include foam cleaning systems that are configured to apply a layer of cleaning foam that breaks down and lifts stubborn dirt, which is then rinsed off with water. In still other embodiments, panel washing systems can include ultrasonic cleaning systems that are configured to use ultrasonic waves to create microscopic bubbles that clean the panel surfaces without physical contact. In some embodiments, panel washing systems can include electrostatic cleaning systems that are configured to utilize electrostatic forces to attract and remove dust and dirt from the panels. In still other embodiments, panel washing systems can include robotic cleaners that are configured to deploy autonomous robots equipped with brushes, water jets, or other cleaning tools to navigate the panel surfaces and perform regular cleaning cycles. In other embodiments, panel washing systems can include manual cleaning systems further including handheld tools, such as brushes, squeegees, and water hoses for manual cleaning, suitable for smaller installations or hard-to-reach areas. In some embodiments, panel washing systems can include air blower systems that are configured to use high-velocity air blowers to remove loose dust and debris from the panels.

According to other embodiments, panel washing systems can include chemical cleaning solutions that are configured to apply specialized chemicals that break down dirt and contaminants, which are then rinsed off with water. In still other embodiments, panel washing systems can include hydrophobic coatings that are applied to the panel surfaces to repel water and dirt, reducing the frequency of cleaning required. In some embodiments, panel washing systems can include electrolytic cleaning systems that are configured to use a mild electric current to clean the panels, effective for removing organic contaminants and biofilms. In some embodiments, panel washing systems can include solar-powered cleaning systems that are configured to utilize solar energy to power the cleaning mechanisms, ensuring energy efficiency and sustainability. In other embodiments, panel washing systems can include vibration cleaning systems that are configured to use mechanical vibrations to dislodge dirt and debris from the panels. In some embodiments, panel washing systems can include steam cleaning systems that are configured to utilize steam to clean the panels, effectively removing dirt and sterilizing the surface.

In still other embodiments, panel washing systems can include magnetic cleaning systems that are configured to use magnetic forces to attract and remove ferrous particles from the panel surfaces. In some embodiments, panel washing systems can include self-cleaning coatings with photocatalytic or super-hydrophilic properties that are configured to help break down organic matter and facilitate easy removal of dirt. In other embodiments, panel washing systems can include rainwater harvesting systems that are configured to utilize rainwater to clean the panels through a controlled system of gutters and sprayers. In some embodiments, panel washing systems can include dry cleaning systems that are configured to microfiber cloths or electrostatic dusters, suitable for areas with limited water availability. In some embodiments, panel washing systems can include integrated cleaning tracks, which can further include tracks installed along the edges of the panels to guide cleaning robots or brushes, ensuring consistent and thorough cleaning. In some embodiments, panel washing systems can include high-frequency vibration systems use high-frequency vibrations to shake off dust and debris from the panels. Those of skill in the art will readily appreciate that any one or more of the embodiments described above can be utilized alone or in combination with another one or more of the embodiments described above.

### Examples of Vessel Hull Embodiments

According to another aspect of the embodiments, apparatus 100 is designed to be a versatile platform that can be combined with a variety of hull designs depending on the specific primary purpose of the vessel. Although the drawings of the present disclosure depict a flat-bottom hull 10, those of skill in the art will recognize that apparatus 100 can be implemented with a wide variety of hull configurations, including but not limited to the following:
Flat-bottom Hull: The anatomy of a flat-bottom hull, such as a barge, revolves around a flat-bottomed keel, chines, bottom plates, transverse frames, and bulkheads. The simplicity and robustness of this design make flat-bottom hulls sought after for transporting heavy cargo in shallow waters and calm conditions.

Round-bottom Hull: A round-bottom hull is a marine vessel design featuring a smooth, curved bottom surface that extends from the keel to the chine on each side. Round-bottom hulls are known for their seakeeping abilities, maintaining stability even in adverse weather conditions. This performance is achieved by the hull's shape, which reduces the surface area in contact with the water compared to flat-bottom designs. Round-bottom vessels tend to have lower hydrodynamic drag compared to some other hull types. While they may not achieve the same high speeds as planing hulls, they offer improved fuel efficiency when cruising at moderate speeds.

V-shaped Hull: A V-shaped hull is a type of marine vessel hull design characterized by its sharp, inverted V-like structure at the bow. The primary feature of the V-shaped hull is its ability to reduce hydrodynamic drag, allowing the vessel to move more efficiently through the water, particularly at higher speeds. As the hull encounters waves, the V-shape helps to disperse the impact forces, resulting in a smoother ride and improved comfort.

Catamaran Hull: A catamaran hull is a unique marine vessel design that features two parallel hulls connected by a deck or platform. The two hulls, spaced widely apart, offer a broad and stable base, reducing the vessel's tendency to roll in rough seas. Catamaran hulls exhibit reduced hydrodynamic drag due to their slender shape and reduced wetted surface area. As a result, catamarans can achieve higher speeds with less power, making them more fuel-efficient compared to other hull designs. This efficiency is appealing for commercial vessels, such as fast ferries and offshore support ships.

Pontoon Hull: Consisting of cylindrical pontoons attached to a deck structure, pontoon boats offer stability and buoyancy, ideal for leisure activities and party boats.

Displacement Hull: A displacement hull is a classic marine vessel design characterized by its full-length keel and rounded bow shape. Displacement hulls are designed to displace water as they move forward, providing unique advantages in specific marine applications. As the vessel moves through the water, it pushes water aside, creating a bow wave and stern wave. This characteristic allows displacement hulls to achieve excellent efficiency, making them ideal for long-distance voyages and ocean crossings. The rounded bow design of the displacement hull allows for smooth entry into the water, resulting in reduced slamming and improved seakeeping capabilities. This, in turn, provides a more comfortable ride for passengers and crew, particularly in rough seas.

Semi-Displacement Hull: Combining features of planing and displacement hulls, this design allows for moderate speed and efficiency. This design is frequently seen in trawlers and some motor yachts.

Planing Hull: Designed to rise and skim on top of the water at high speeds, planing hulls reduce drag and deliver thrilling performance for speedboats and racing vessels.

Hydrofoil Hull: Equipped with underwater wings (hydrofoils), this design lifts the hull above the water's surface, reducing drag and enabling high-speed, fuel-efficient travel.

Small Waterplane Area Twin Hull (SWATH): Featuring two submerged parallel hulls, this design minimizes wave-induced motion, providing a stable platform for research vessels and offshore support ships.

Knuckle Hull: Characterized by a pronounced step or “knuckle” in the hull's design, this type decreases drag and improves efficiency, often used in fast ferries and patrol boats.

Monohull: The classic single-hull design offers versatility and simplicity, seen in a wide range of vessels, from sailboats and fishing boats to large cargo ships.

Trimaran Hull: Utilizing three parallel hulls, trimarans combine stability and speed, commonly found in racing sailboats and military vessels.

Small Waterplane Area Single Hull (SWASH): This innovative design uses a single, submerged hull, reducing resistance and enabling high speeds, suitable for fast ferries and military crafts.

Hard Chine Hull: Featuring a distinct, sharp edge where the hull meets the deck, hard chine hulls offer stability and carrying capacity, frequently used in workboats and fishing vessels.

Multi-chine Hull: Utilizing multiple flat panels along the hull's sides, this design enhances stability and load-carrying ability, commonly seen in small recreational boats and dinghies.

Round-chine Hull: Smoothly curving from the hull's sides to the bottom, this design provides better performance and comfort, popular in sailboats and smaller powerboats.

Wave-piercing Hull: Primarily used in high-speed vessels, this design slices through waves instead of riding on top, reducing slamming and improving fuel efficiency.

Inverted Bow Hull: With a reversed or “wave-piercing” bow, this design reduces wave impact, enhancing comfort and stability in challenging sea conditions.

X-Bow Hull: Boasting a unique X-shaped bow, this design increases seakeeping capabilities and efficiency, reducing slamming and spray on vessels like offshore support ships and research vessels.

### Example Embodiments of Drag Reduction Techniques

Generally, optimizing the hull shape to minimize resistance through streamlined designs can significantly reduce drag. Several drag reduction techniques, each of which can be utilized with any of the embodiments described herein, will now be described. For example, according to some embodiments, implementing micro-bubbles along the hull can create a lubricating layer, reducing friction between the hull and water. In other embodiments, adjusting the length-to-beam (L/B) ratio of the vessel can also enhance hydrodynamic efficiency. In still other embodiments, using lighter materials, including lightweight solar panels, can reduce the overall weight of the vessel, thereby decreasing drag. In some embodiments, the skid height for the floating solar panels can be optimized to ensure minimal water resistance. Furthermore, applying advanced coatings, such as micro-ribs and epoxy, to both the hull and skids can further reduce drag by creating smoother surfaces.

Innovations in propeller design can also improve propulsion efficiency, reducing the energy required to overcome drag. Incorporating positive buoyancy materials like helium or foam within the skids and hull can help maintain optimal buoyancy and reduce drag. Employing anti-fouling techniques such as acoustic deterrents, chemical treatments, and cleaning robots can prevent the buildup of marine organisms on the hull and skids, maintaining their hydrodynamic efficiency. Additionally, integrating air lubrication systems that inject a layer of air between the hull and water can significantly reduce drag. Utilizing superhydrophobic coatings can create a water-repellent surface, further decreasing friction. Implementing active hull surface control systems that adjust the hull shape in response to water flow conditions can optimize hydrodynamic performance in real-time. Employing advanced materials such as graphene-enhanced composites can provide superior strength-to-weight ratios and reduce overall drag. Incorporating vortex generators on the hull can manage water flow more effectively, reducing turbulence and drag.

Furthermore, according to some embodiments, using flexible solar panels that conform to the shape of the vessel can minimize aerodynamic drag. Implementing retractable skids that adjust their height based on sea conditions can also enhance drag reduction. Likewise, utilizing bio-inspired designs, such as mimicking the texture of shark skin, can further reduce drag and improve the vessel's efficiency. Additionally, employing dynamic positioning systems to optimize the vessel's orientation relative to currents and wind can further reduce drag. Integrating advanced computational fluid dynamics (CFD) simulations during the design phase can help identify and mitigate potential drag sources. In addition, using hybrid propulsion systems that combine solar power with other renewable energy sources, such as wind or wave energy, can optimize overall energy efficiency and reduce drag. Furthermore, incorporating boundary layer control techniques, such as suction or blowing, can manage the flow of water around the hull, reducing drag. Utilizing advanced hull coatings with nanotechnology can create ultra-smooth surfaces that minimize resistance. Implementing energy-saving devices like pre-swirl stators and rudder bulbs can optimize water flow and reduce drag.

In addition, according to some embodiments, integrating real-time monitoring systems to continuously assess and adjust the vessel's performance can ensure optimal drag reduction throughout its operation. Incorporating hydrofoils can lift the hull out of the water at higher speeds, significantly reducing drag. Utilizing adaptive hull materials that change shape in response to water flow can optimize hydrodynamic performance. Integrating kite sails can harness wind power to reduce the load on the propulsion system, thereby reducing drag. Employing automated trim control systems can continuously adjust the vessel's trim to minimize drag. Utilizing advanced ballast systems that adjust in real-time to optimize vessel stability and reduce drag. Those of skill in the art will readily appreciate that any one or more of the embodiments described above can be utilized alone or in combination with another one or more of the embodiments described above.

### Example Embodiments of Vessel Powertrain and Power Source Options for Use with Apparatuses for Solar Energy Collection for a Marine Vessel

According to another aspect of the embodiments, while apparatus 100 can function as an exclusive source of power for vessels of a certain profile, and up to a certain weight, apparatus 100 can also function as a partial power source to a vessel. In particular, apparatus 100 and its provided solar power may integrate with diverse power sources based on the vessel's specific requirements. When apparatus 100 and/or its solar power are referenced, it can include an onboard battery module, solar inverter, and powertrain. The present disclosure encompasses its integration with a range of power configurations including, but not limited to the following:
Exclusively solar power: Any vessel which is capable of carrying out its journey without any additional supplementary power source. Such a vessel would consist of a completely electric powertrain where all required and utilized power is a result of harvesting energy from the onboard solar array supported by the apparatus.

Solar power and battery hybrid: This solution consists of the onboard solar system and a modular battery system with exchangeable batteries at ports. This hybrid propulsion system combines the apparatus and additional battery technology to enhance operational efficiency. The apparatus is supplemented by additional energy capacity in the form of either modular or permanent batteries. This energy may come from excess solar power from the apparatus, from an on grid power system when at a port, from a supplemental off-grid energy source when at a port, a supplemental off-grid energy source when not at port, or energy transferred from other ships. Batteries may be permanently affixed to the vessel or of a modular design, capable of being removed and replaced by more charged batteries at a port or any other point along the route of the vessel.

Solar power and diesel hybrid: This solution consists of the onboard solar system and a traditional diesel powertrain. The powertrain of the vessel would be able to switch from electric energy (harvested from the apparatus solar panels) to a traditional combustion source of power such as a diesel engine.

Solar power and green energy hybrid: This solution consists of the onboard solar system and one or more alternate power sources such as wind, solar sails, nuclear, liquid/compressed natural gas, hydrogen fuel cell, or hydroelectric. The powertrain of the vessel would be able to harness and utilize the electrical power generated by the various sources of energy generation on the vessel.

### Example Embodiments of Alternative Apparatus Designs

While the embodiments depicted in the figures are the primary design for apparatus 100, there are a number of other embodiments which could be used to achieve comparable results. The following alternative embodiments are within the scope of the present disclosure. For example, with respect to the accordion configuration of panel structure 60 (FIG. 11), different methods for actuating the accordion configuration include the use of winches, electric motors, or even a manual actuator. As another example, instead of the accordion configuration, an alternative embodiment can utilize panel structures that can be stacked or configured to slide over each other, such as in a telescoping manner, to expand the surface area. In some embodiments, such stacking or sliding actions can be driven by one or more hydraulic motors.

In yet another alternative embodiment, flexible solar panels can be employed such that an array of panels that is collapsible into a slider profile roll of panels is possible. Such a mechanism might consist of a winch or electric motor system to roll and unroll a centrally stored set of panels. In the unrolled state surface area would be maximized and in a rolled up state all of the panels would fit as needed within the profile of the vessel.

In certain embodiments, configurations can be employed where the solar panels are largely or entirely fixed, for example a string of solar panels extending behind the hull like a wedding trail or panels sitting on top of hulls or foils to the side or the ship similar to a motorcycle sidecar.

In other embodiments, configurations can be employed where the solar panels are stacked vertically and pointed to the sun. This would serve a double function as it would also potentially provide thrust in the form of wind power and would be easier to point the solar panels directly at the sun. According to one aspect, these embodiments could utilize gravity to close and a man-powered winch and pulley system to raise up.

In yet another alternative embodiment, folding collapsible panels can be employed. In particular, configurations can be employed where solar panels are folded symmetrically and tucked away for easy storage. Such embodiments could be folded into the dimensions of one solar panel in length, allowing for easier access to parts of the barge for maintenance.

In addition to, or in lieu of the aforementioned embodiments, further surface areas can be employed, such as, for example, smaller solar panels that can be added to the surface of various smaller boat parts like railings, hatch covers, awnings, antennas or sails.

As another alternative embodiment, restricted lateral movement designs can be employed. Such designs are configured to achieve increased surface area, but sacrifice the ability to load the vessel from above. However, such a design may be acceptable in certain cases, such as for a tanked vessel where liquid is loaded and unloaded from more easily accessible points on the vessel.

As another alternative embodiment, panel collapse mechanisms can be employed in which the panels are expanded and or compacted in a direction that is parallel to the width of the ship. In these embodiments, the panel collapse mechanism would alternate from an expanded state where the panels exceed the width of the vessel and a collapses state where the panels are retracted to fit within the width of the vessel. In further alternative embodiments utilizing panels that expand and collapse along the width of the vessel, such panels can be split into separate sections to permit top-loading of the vessel.

As another alternative embodiment, a panel design can be employed comprising a primary panel array configured to cover the surface area of the vessel, along with one or more secondary side panel arrays along the width of the vessel which rotate about an axis parallel to the length of the vessel. This apparatus can be powered by an electric motor. In the expanded configuration, the one or more secondary side panel arrays are aligned such that they extend and/or maximize the solar surface area. In the compacted state, the one or more secondary side panel arrays are either perpendicular to the primary panel array, or rotated a full 180 degrees to fold completely against the primary panel array.

As yet another alternative embodiment, a design can be employed comprising layers of triangular pieces to expand the available surface area of the vessel. Such an apparatus would have a fixed main panel array to cover the surface area of the barge, and layers of panel on top which are capable of sliding out along tracks or another mechanism. The rails would be able to retract within the profile of the barge when the panels are contracted but able to rotate out at the required angle when necessary. The most conducive shape to the deployable panel sections is a series of triangles. Other variations of a triangle based orientation could be implemented, and are within the scope of the present disclosure, including those which subdivide other triangles, designs which reorient similar triangles while maintaining their shape, and designs which use different but functional similar geometric divisions of the barges surface are all fulfill the same function and are fundamentally the same design.

Many of the above described designs will likely require additional support in order to remain capable of expansion and collapse, such as the following. In some embodiments, buttress supports can be used, which are triangular supports with one side parallel to the supports of the apparatus and another side parallel to the expanded panel array. Buttress supports can be configured to allow the panel array or apparatus to transfer the weight of its overhanging load back to the main barge. Buttress supports may be connected to the barge directly and swing in to fit within the profile of the ship or may be a deployable piece of the apparatus. In some embodiments, in-water supports can be used, which comprise a separate buoyant piece which directly supports a part of the apparatus and allows the apparatus to transfer the overhanging load directly to the water for support. Similarly, in some embodiments, hydrofoils or other similarly aerodynamically advantaged profiles can be used for parts of in-water supports which come in contact with the water. In some embodiments, mounting an apparatus in a method using a second barge or the associated tug also constitutes as use of an in-water support as they transfer the load of the apparatus to the water directly, but are not part of the primary barge structure.

It will be generally understood by those of skill in the art that, although many of the embodiments described herein are directed to shipping vessels configured to transport cargo, any of the methods, apparatuses, componentry, and features thereof can be implemented for other applications, including, but not limited to: passenger transportation (e.g., passenger vessels, cruise ships, ferries, and yachts); offshore operations (e.g., offshore platforms and installations, oil rigs, wind farms, and research stations); recreational boating (e.g., sailboats and yachts); coastal surveillance and research (e.g., vessels with monitoring systems, sensors, and research equipment); aquaculture and fisheries operations (e.g., vessels for transporting harvested fish, delivering supplies, and conducting research and surveillance in aquatic environments); humanitarian aid and disaster relief (e.g., vessels for transporting supplies, food, and medical equipment to affected regions); and research and development.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. An apparatus for collecting solar energy for a marine vessel, the apparatus comprising:
a plurality of solar panel sections comprising a plurality of solar panels;
multiple floating structures coupled to each of the plurality of solar panel sections, wherein each floating structure comprises a hull that is shaped to reduce hydrodynamic drag while the multiple floating structures are trailed on a water surface behind the marine vessel; and
a support structure connected with each of the multiple floating structures and the solar panel section, wherein the multiple floating structures are longitudinally positioned and support the solar panel section while trailing the plurality of solar panel sections about the water surface.

2. The apparatus of claim 1, wherein each floating structure further comprises:
a bow shaped to displace water as the multiple floating structures are trailed on the water surface.

3. The apparatus of claim 1, wherein the multiple floating structures are catamaran-style structure with dual pontoons connected by the support structure for load distribution of the solar panel section.

4. The apparatus of claim 1, wherein each of the multiple floating structures are hollow or have a foam filled with an interior of the floating structure.

5. An apparatus for collecting solar energy for a marine vessel, the apparatus comprising:
multiple solar panel sections, comprising a plurality of solar panels;
multiple floating structures coupled to each of the multiple solar panel sections, wherein each floating structure comprises a hull that is shaped to reduce hydrodynamic drag while multiple floating structures are trailed on a water surface behind the marine vessel; and
a support structure connected with each of the multiple floating structures and the solar panel section, wherein the multiple floating structures are longitudinally positioned and support the solar panel sections while trailing the solar panel sections about the water surface;
wherein the multiple solar panel sections are separate independently floating sections interconnected via wiring to one another.

6. The apparatus of claim 5, wherein the multiple solar panel sections have buffers to absorb impact forces during lateral collisions of the separate independently floating sections.

7. The apparatus of claim 5, wherein each floating structure further comprises:
a first solar panel section with multiple floating structures having a bow shaped to displace water as the multiple floating structures are trailed on the water surface; and
a second solar panel section with multiple floating structures, with multiple floating structures;
wherein a first floating structure of the first solar panel section is connected to a first floating structure of the second solar panel section, and a second floating structure of the first solar panel section is connected to a second floating structure of the second solar panel section.

8. The apparatus of claim 5, wherein the multiple floating structures are catamaran-style skids with dual pontoons connected by the support structure for load distribution of the solar panel section.

9. An apparatus for collecting solar energy for a marine vessel, the apparatus comprising:
multiple solar panels configured to transform between a plurality of configurations, including a deployed configuration and a stored configuration;
multiple floating structures coupled with each of the multiple of solar panels; and
a storage system configured for storing the multiple solar panels in the stored configuration;
wherein in the deployed configuration, the multiple solar panels and the multiple floating structures are configured to trail behind a stern portion of the marine vessel on a surface of water and form a trailing platform behind the marine vessel, wherein the trailing platform is configured to be operatively tethered to the stern portion of the marine vessel;
wherein in the stored configuration, the multiple solar panels are configured to be stored in the storage system in or on the marine vessel, and the plurality of solar panels are configured to be compacted together and disposed in the storage system.

10. The apparatus of claim 9, wherein the storage system comprises a housing, and comprises a retraction mechanism to retract the trailing platform of the multiple solar panels from the water.

11. The apparatus of claim 9, wherein in the deployed configuration, the trailing platform is configured to be operatively tethered to the stern portion of the marine vessel.

12. The apparatus of claim 9, wherein the storage system comprises storage tracks and an attachment cable that is configured to remain connected during storage and deployment of the multiple solar panels.

13. The apparatus of claim 9, wherein the storage system comprises a retraction mechanism having a chain and hook mechanism and a track and wheel mechanism to guide the floating structures along a predefined path.

14. The apparatus of claim 9, further comprising a deployment mechanism configured to deploy into the water and/or withdraw from the water the multiple solar panels.

15. The apparatus of claim 9, the apparatus further comprising a panel washing system comprising moveable brushes and/or a water spaying system configured to clean the panels.
